(19) United States
(12) Patent Application Publication
(10) Pub. No.: US 2013/0305601 A1
(43) Pub. Date: Nov. 21, 2013

(54) PLANT CULTIVATION SYSTEM

(71) Applicant: Young Hwan PARK, Pyeongtaek-si (KR)

(72) Inventor: Young Hwan PARK, Pyeongtaek-si (KR)

(21) Appl. No.: 13/398,155

(22) Filed: Feb. 16, 2012

(30) Foreign Application Priority Data
Feb. 17, 2011 (KR) 10-2011-0014232

(51) Int. Cl. A01G 31/04; A01G 9/14

(52) U.S. Cl. CPC A01G 31/045; A01G 31/04; A01G 9/14
USPC 47/17; 47/66.6

(57) ABSTRACT

The plant cultivation system includes: a circulatory system including axises installed in a corresponding portion of a frame installed in a cultivation room; chain gear axis-installed in the axises respectively; a left and a right chains; and a deduction motor connected and installed onto any axis of the axises; cultivating pot members including a can body, and a hook plate, fixed to left and right ends of the upper surface of the can body; and for moving and circulating in the inner space of the cultivation room by rotatably installing as hanging between the left and a right chains by the left and right hook axises and the hook plate; a medicinal fluid supplier; and an air blower, installed in the cultivation room.

### CROSS-REFERENCE TO RELATED APPLICATION

This application claims priority from Korean Patent Application No. 10-2011-0014232, filed on Feb. 17, 2011, in the Korean Intellectual Property Office, the disclosure of which is incorporated herein by reference in its entirety.

### BACKGROUND OF THE INVENTION

1. Field of the Invention

The present invention relates to a plant cultivation system, more particularly to a plant cultivation system for environmentally growing a variety of plants with all-weather, regardless of the natural environment or a place and for significantly increasing the production per unit area.

2. Description of the Related Art

In general, a glass greenhouse or a vinyl greenhouse can cultivate fruit-type vegetables such as cucumber, tomatoes, cherry tomatoes, peppers, and etc., leafy vegetables such as celery, lettuce, water parsley, cabbage, Chinese cabbage, and flowering plant such as roses, gerbera, chrysanthemums, carnations, etc. Accordingly, farmers can increase in revenue and consumers are able to ingest the various and fresh plants in the winter.

However, this glass greenhouse or vinyl greenhouse is constructed on the ground such as farmland or the livered area, and the corresponding plants are grown by the manner that of sowing the seeds of those plants on the ground or transplanting seedlings grown in the nursery, while there were problems that the production is limited ever growing space or per unit area and the damage due to the repeated cultivation is created.

Thus, to increase the production in limited cultivation area, to reduce the workforce, and to reduce the damage caused by the repeated cultivation, farmers can cultivate in manner that of arranging the plants with a multi-stages in cultivating space in prior art.

However, this cultivating manner have the problem that of adversely affecting to the plants cultivation in the bottom of the multi-stages, since the sun for lighting to the plants located on the bottom, is blocked by the plants in highest top, bed, or plant pots planted their roots in the highest top.

In addition, the other prior art have suggested that the interval between beds or plant pots in the highest top or lowest bottom spaced out to solve these problems. But these prior art have still the problem that of relatively reducing the production due to not construct multi-stage and thus falling the economic feasibility.

To overcome these problems, the worker can cultivate the plants with a more multi-stages extended to vertical and horizontal directions. But the worker does not directly reach the higher places of the plants or the fruits in the harvest season, and the worker have to use a ladder. Therefore, these prior manner also uncomfortable and is required a lot of time and manpower.

### SUMMARY OF THE INVENTION

The problem to be solved by the claimed invention consists in development of a plant cultivation system. An object of the present invention is to provided to a plant cultivation system for environmentally growing and quickly and smoothly harvesting a variety of plants.

An object of the present invention is to provide a plant cultivation system for maximizing the ability of space usage by cultivating the plants with all-weather.

A further other object of the present invention is to provide to a plant cultivation system for simply and easily performing the cultivation management and the harvest work, and for reducing labor time and the waste of human.

A still other object of the present invention is provide to a plant cultivation system for not required the time of injecting medicine into the plants, and for preventing from failure for circulatory in the plant cultivation system.

A yet other object of the present invention is provide to a plant cultivation system for achieving the simple structure and the low installation costs, and for simply and easily transplanting germinated plants to plant and cultivate in cultivating pots.

To achieve these objects and other advantages and in accordance with the purpose of the invention, as embodied and broadly described herein, a plant cultivation system comprising: a circulatory system 20 including a plurality of axises 24 installed in a corresponding portion of a frame 13 installed in a cultivation room 10; a plurality of chain gear 22 axis-installed in the plurality of axises 24 respectively; a left and a right chains 23 for chaining the plurality of chain gear 22 to be hanged by turn; and a deduction motor 21 connected and installed onto any axis of the plurality of axises 24; a plurality of cultivating pot members 30 including a can body 31 having an opening in an upper surface, and a hook plate 32, fixed to left and right ends of the upper surface of the can body, for axis coupling and installing by hanging onto left and right hook axises 26 horizontally fixed in an inner space of the left and a right chains 23 which is faced each other at regular intervals; and for moving and circulating in the inner space of the cultivation room 10 by rotatably installing as hanging between the left and a right chains 23 by the left and right hook axises 26 and the hook plate 32; a medicinal fluid supplier 40 for providing the medicinal fluid to the plurality of cultivating pot members 30; and an air blower 50, installed in the cultivation room 10, for providing the filtered external air to an interior or for circulating the inner air.

Here, the plant cultivation system further comprises a plurality of lamps 60 installed onto the frame 13 at regular intervals to be traversed toward left and right for the moving direction of the cultivating pot member 30, and a reflector 10a, installed in an inside of the cultivation room 10, for refracting sunlight shinning around the circulatory system 20 to the cultivating pot member 30

According to the present invention, the plant cultivation system provides an improved plants cultivating manner that of moving in a cycle for a plurality of planting pots sowed the seeds of the plants or transplanted seedlings of the plants. Thus, the plant cultivation system allows to evenly receive sunlight for ensuring the constant growth characteristics, when the bed or plant pots are arranged with multi-stages to be extended the upper or lower directions in the internal space of a cultivation room. Therefore, the plant cultivation system of the present invention can obtained advantages that the various plants are grown in a short period of time and the plants are harvested in large quantities.

In addition, according to the plant cultivation system of the present invention, farmers can cultivate the plants with all-weather, regardless of the natural environment or a place by supplying the light energy provided from the number of lamps installed in the lower part where the sunlight is not shinning completely, and the production per unit area is grown in large quantity since the plants more quickly and smoothly are grown in the plant pots.

In particular, according to the plant cultivation system of the present invention, the insect attack is not break out, the productivity and the workability are maximized, a waste of time and manpower are solved naturally, since the farmers cultivate the plants with sterilized nutrient, sandy loam, culture soil, and manage and harvest the plants or their fruits in a constant place.

In addition, according to the plant cultivation system of the present invention, the farmers can cultivate a variety of plants by using one cultivation system because of easily controlling the installation interval of the cultivating pots. Thus, the farmer can grow the plants which stem is spread out such as strawberries with the same cultivating system.

And, the plant cultivation system of the present invention can inject medicinal fluid to the plants in a state that the cultivating pots orbite without stopping to inject the medicinal fluid in the cultivating room. Thus, it is not required separated for injecting the medicinal fluid, and it have not breakdown caused by overloading in a reduction motor since the circulatory system does not repeat stop-and-go operation.

In addition, according to the plant cultivation system of the present invention, the frame structure is simple and the construction cost also come not expensive, because the chain gears are installed in corresponding place of each frame without using the long axis.

In addition, according to the plant cultivation system of the present invention, the plants is easily and simply moved in a short space of time, since the plant pots are loaded in the cultivating pots after moving nurseries where an plurality of plant pots are arranged, while the plant pots are not separated according to the kind of plants, which is germinated from seeds at an plurality of plant pots in nurseries vertically and horizontally arranged in multi-stages.

### BRIEF DESCRIPTION OF THE DRAWINGS

Various features, aspects and benefits of the embodiments of the invention will become apparent and more readily appreciated from the following description of the embodiments, taken in conjunction with the accompanying drawings, of which:

FIG. 1 is a side view of schematically illustrating a plant cultivation system in accordance with the first embodiment of the present invention.

FIG. 2 is an enlarged plane view of illustrating a main part of the plant cultivation system of FIG. 1.

FIG. 3 is an enlarged side view of illustrating a main part of the plant cultivation system of FIG. 1, in condition that reflectors are omitted.

FIG. 4 is an enlarged side view of illustrating specific part in FIG. 3.

FIG. 5 is a front view of illustrating specific part in FIG. 4.

FIG. 6 is an enlarged side view of illustrating moving state of a chain and cultivating pots in FIG. 4.

FIG. 7 is an enlarged rear view of illustrating a guide rail in FIG. 4.

FIG. 8 is an enlarged perspective view of illustrating a cultivating pot member in FIG. 1.

FIG. 9 is an enlarged deal perspective view of illustrating a main part of the cultivating pot member in FIG. 8.

FIG. 10 is an enlarged side sectional view of illustrating an example of the cultivating pot member in FIG. 8.

FIG. 11 is an enlarged side sectional view of illustrating the other example of the cultivating pot member in FIG. 8.

FIG. 12 is a side view of schematically illustrating a plant cultivation system in accordance with the second embodiment of the present invention.

FIG. 13 is a front view of illustrating specific part in FIG. 12.

FIG. 14 is a side view of schematically illustrating a plant cultivation system in accordance with the third embodiment of the present invention.

FIG. 15 is an enlarged rear view of illustrating a plant cultivation system of FIG. 14.

FIG. 16 is an enlarged plane view of illustrating a main part of a plant cultivation system of FIG. 14.

FIG. 17 is an enlarged rear view of illustrating a main part of a plant cultivation system of FIG. 14.

FIG. 18a is an enlarged perspective view of illustrating a cultivating pot member in FIG. 14.

FIG. 18b is an enlarged side view of illustrating a cultivating pot member in FIG. 18a.

FIG. 18c is a separated perspective view of illustrating a main part of a cultivating pot member in FIG. 18a.

FIG. 19a is a perspective view of illustrating other example of a cultivating pot member applied in FIG. 14.

FIG. 19b is an enlarged perspective view of illustrating a main part of a cultivating pot member of FIG. 14.

FIG. 20a is an enlarged side view of illustrating a main part of a medicinal fluid supplier in FIG. 14.

FIG. 20b is a side view of illustrating a state that a cylinder is forwardly operated in FIG. 20a.

FIG. 21a is an enlarged side view of illustrating a main part of a medicinal fluid supplier in FIG. 20a.

FIG. 21b is a side view of illustrating the operation state of a medicinal fluid supplier in FIG. 21a.

FIG. 22 is a perspective view of illustrating another example of a cultivating pot member applied in FIG. 14.

FIG. 23 is a side view of schematically illustrating a plant cultivation system in accordance with the forth embodiment of the present invention.

FIG. 24 is a plane view of illustrating a plant cultivation system of FIG. 23.

FIG. 25 is a side view of illustrating a main part of a plant cultivation system of FIG. 23.

FIG. 26 is an enlarged plane view of illustrating a main part of a plant cultivation system in FIG. 24.

FIG. 27 is an enlarged rear view of illustrating a main part of a plant cultivation system in FIG. 24.

FIG. 28a is an enlarged perspective view of illustrating a cultivating pot member in FIG. 24.

FIG. 28b is an enlarged side view of illustrating a cultivating pot member of FIG. 28a.

FIG. 28c is an enlarged and separated perspective view of illustrating a main part of a cultivating pot member in FIG. 28a.

FIG. 29a is an enlarged plane view of illustrating a main part of a medicinal fluid supplier in FIG. 24.

FIG. 29b is a plane view of illustrating a state that a cylinder is forwardly operated in FIG. 29a.

FIG. 30a is an enlarged side view of illustrating an installation place of a medicinal fluid supplier in FIG. 29a.

FIG. 30b is a side view of illustrating the operation state of a medicinal fluid supplier in FIG. 30a.

FIG. 31 is an enlarged sectional view of illustrating a state that medicinal fluid is supplied to a cultivating pot member in FIG. 30a.

### DETAILED DESCRIPTION OF EXEMPLARY EMBODIMENTS

Hereinafter, the detailed description of a plant cultivation system in accordance with an embodiment of the present invention will be described in accordance with the accompanying drawings as follows.

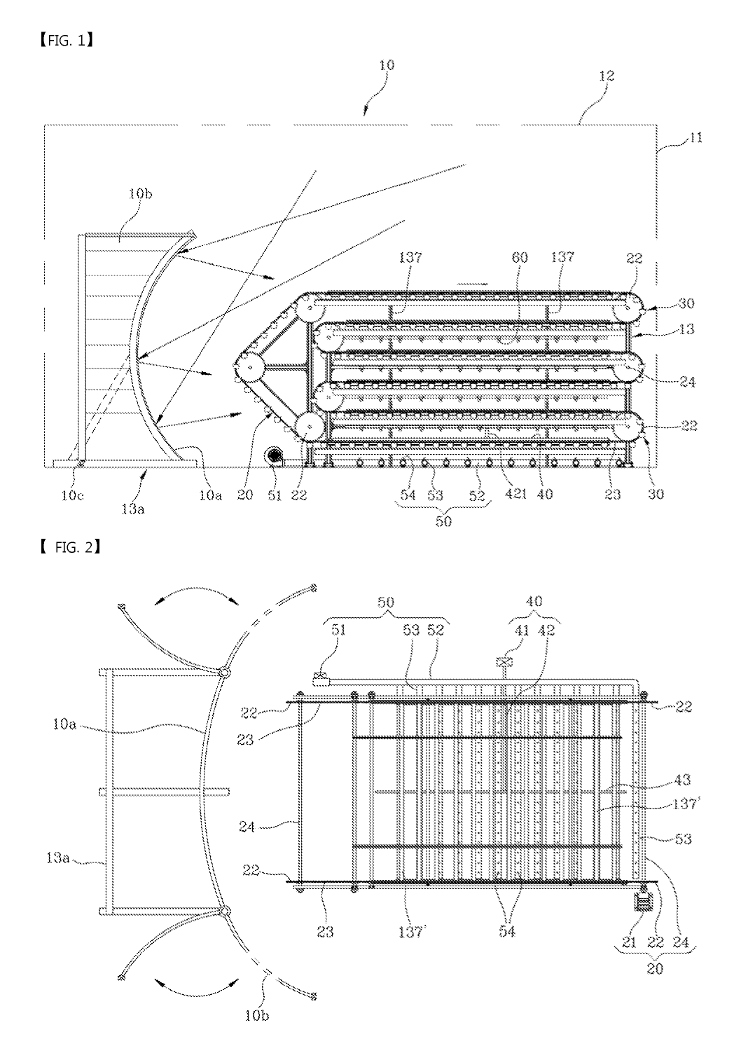

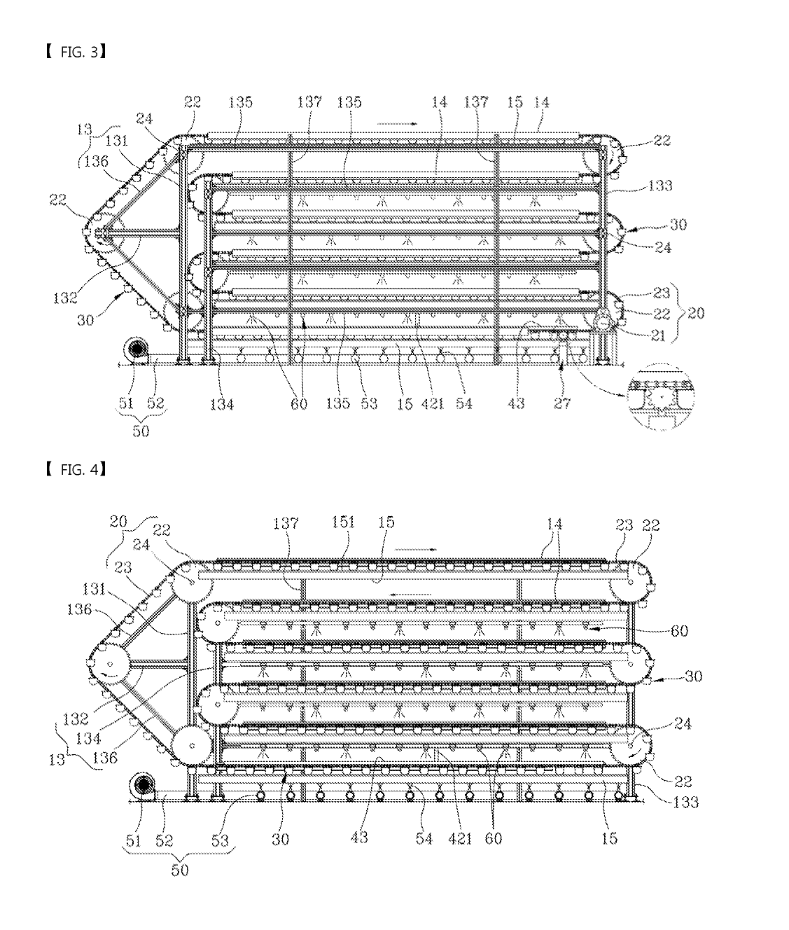

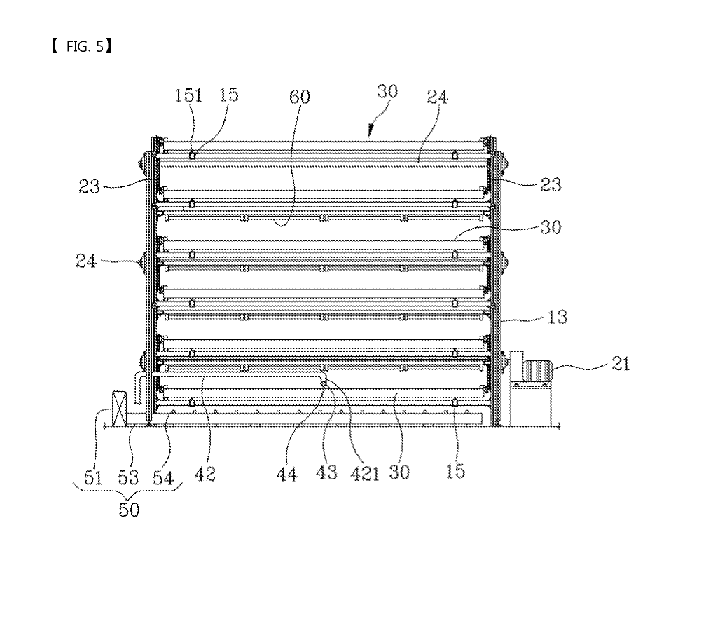

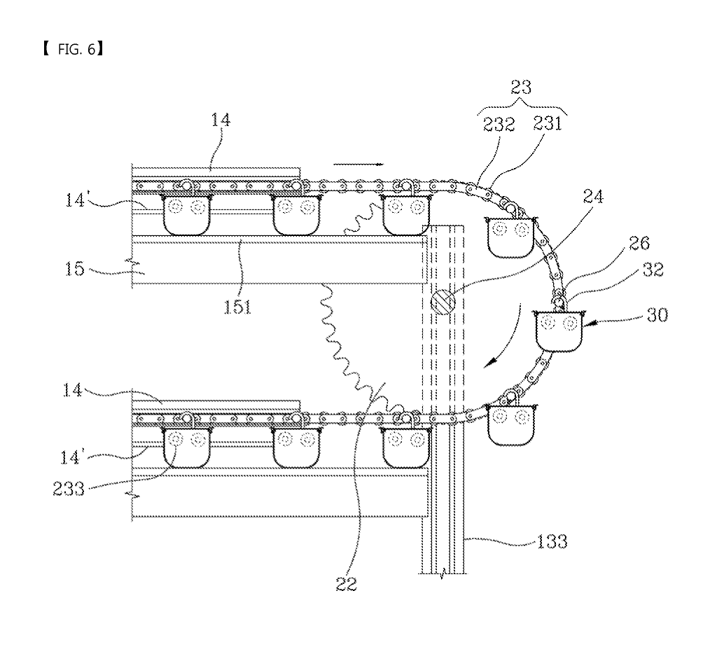

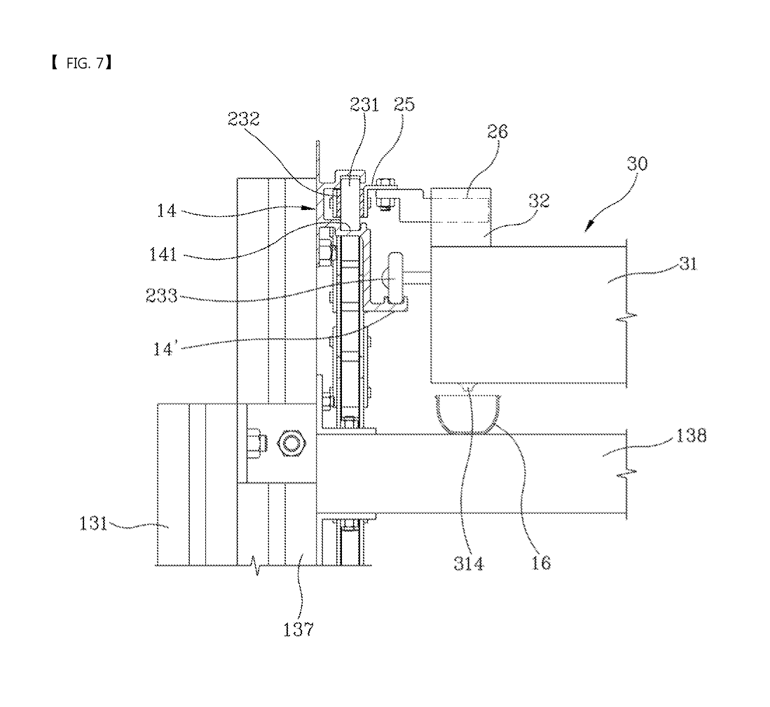

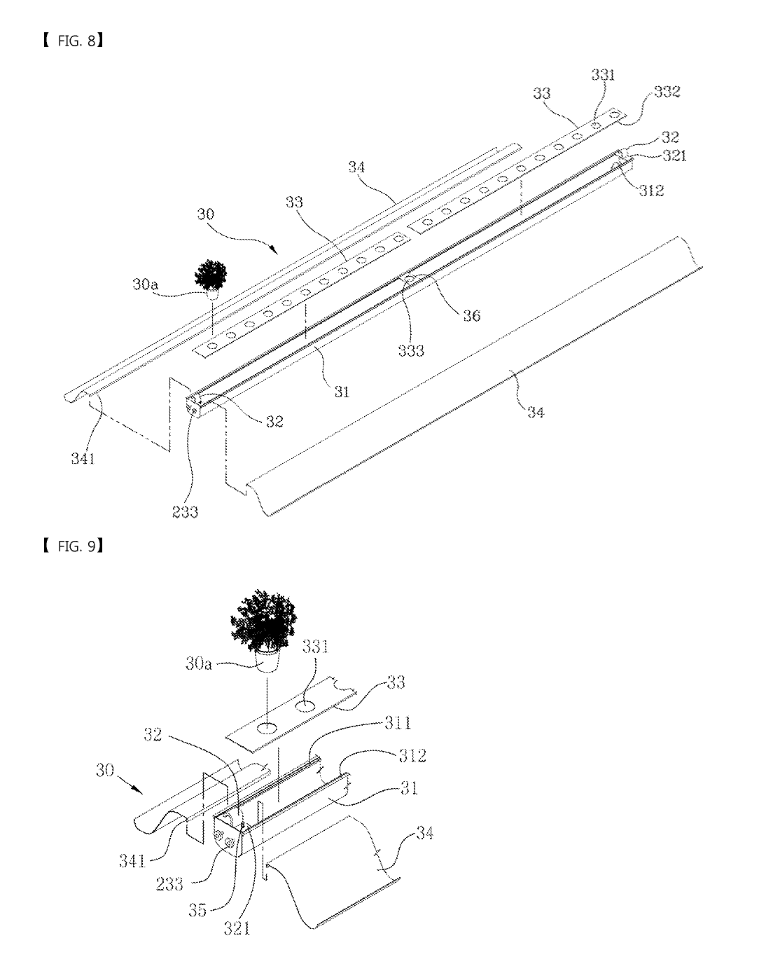

FIG. 1 is a side view of schematically illustrating a plant cultivation system in accordance with the first embodiment of the present invention; FIG. 2 is an enlarged plane view of illustrating a main part of the plant cultivation system of FIG. 1; FIG. 3 is an enlarged side view of illustrating a main part of the plant cultivation system of FIG. 1, in condition that reflectors are omitted; FIG. 4 is an enlarged side view of illustrating specific part in FIG. 3; FIG. 5 is a front view of illustrating specific part in FIG. 4; FIG. 6 is an enlarged side view of illustrating moving state of a chain and cultivating pots in FIG. 4; FIG. 7 is an enlarged rear view of illustrating a guide rail in FIG. 4; FIG. 8 is an enlarged perspective view of illustrating a cultivating pot member in FIG. 1; FIG. 9 is an enlarged deal perspective view of illustrating a main part of the cultivating pot member in FIG. 8; FIG. 10 is an enlarged side sectional view of illustrating an example of the cultivating pot member in FIG. 8.

The plant cultivation system of the first embodiment of the present invention includes: a cultivation room 10; a circulatory system 20 which is installed on the inside of the cultivation room; a plurality of cultivating pot members 30 arranged with a constant internal in the circulatory system 20 to rotatably move the internal space of the cultivation room 10; a medicinal fluid supplier 40 for providing medicinal fluid to the plurality of cultivating pot members 30; and an air blower 50 for providing the filtered external air to an interior of the cultivation room 10 or for circulating the inner air of the cultivation room 10 or exhausting the inner air to an outside.

The cultivation room 10 is constructed with four walls 11 and ceiling 12 by using vinyl, transparent plastic boards, acrylic resin, or glass etc. such as a typical glass greenhouse or vinyl greenhouse, and a door is generally installed on one wall among the four walls for cultivation and harvest management.

And, a reflector 10a is installed in an inside of the cultivation room 10 since the sunlight shinning around the circulatory system 20 is provided to the cultivating pot member 30.

To this end, a reflector 10a having a reflective surface formed with curved surface is installed to be supported by a supporting frame 13a where the sunlight is received the most around a frame 13 according the installing direction of the cultivation room 10. Then, the light energy is increasingly provided by reflecting sun light collected around the reflector 10a to the cultivating pot member 30.

A secondary reflector 10b is coupled by using a hinge in the left and right place of the reflector 10a, and a wheel 10c is installed in each bottom of the reflector 10a. A user can fully unfold or expand at the appropriate angle depending on their needs, the sun light can be more effectively reflected to the cultivating pot member 30.

The circulatory system 20 includes a deduction motor 21, a plurality of chain gear 22, and a left and a right chains 23, while the plurality of chain gear 22, and a left and a right chains 23 are equipped to be able to take full advantage of the internal space in view of the height or the width of the cultivation room 10 as well as the kind of plants.

For example, in case the cultivation room 10 with an interior space such as FIG. 1 is installed, there are installed in the cultivation room 10 with the frame 13 including a left and right of front vertical beam 131; a left and right horizontal beam 132 in which each rear part is fixed to the front vertical beam 131 to be forwardly extended to an outside; a left and right of rear vertical beam 133; a left and right vertical beam 134 directly located in rear place of the front vertical beam 131; a plurality of left and right horizontal support beams 135 for horizontally connecting and fixing to both an upper and a lower portions and an intermediate portion of the front vertical beam 131, the rear vertical beam 133 and the left and right vertical beam 134, and a plurality of left and right incline support beams 136 for slopingly connecting and fixing to the left and right horizontal beam 132 and the plurality of left and right horizontal support beams 135.

And, in case that the interval between the front vertical beam 131, the rear vertical beam 133 and the left and right vertical beam 134 increased, at least one or more left and right vertical support beam 137 are fixed and installed in each inner side of the left and right horizontal support beams 135 to be traversed up and down directions to enforce the frame 13, as considering the size of the interval.

On the other hand, the plurality of chain gears 22 are axis-fixed in the both ends of each axis 24 installed to be traversed at left and right in corresponding portions that of each upper end and lower end of the front vertical beam 131, each front end of the left and right horizontal beam 132, and each upper end, middle end, and lower end of the left and right vertical beam 134.

In addition, the left and right chain 23 is installed to be horizontally chained and moved through a chain gear 22 located in each lower end of the left and right of front vertical beam 131, a chain gear 22 located in the upper end of the front vertical beam 131 through a chain gear 22 located in the front end of the left and right horizontal beam 132, a chain gear 22 located in the upper end of the rear vertical beam 133, a chain gear 22 located in the upper end of the left and right vertical beam 134, a chain gear 22 located in the middle end of the rear vertical beam 133, a chain gear 22 located in the middle of the left and right vertical beam 134, and a chain gear 22 located in the lower end of the rear vertical beam 133, respectively.

It is installed like above manner, the practical ability of the inner space will be maximized by installing a lot of cultivating pot members 30 as compared to the inner space of the cultivation room 10 as described hereinafter, since the chain 23 goes through from the upper end of the front vertical beam 131 to both the upper end of the rear vertical beam 133 and the left and right horizontal beam 132, then horizontally moves along to “E.” shape between the rear vertical beam 133.

In addition, to move through the chain gear 22 located in the front end of the left and right horizontal beams 132, is to greatly increase the workability by letting the user manages or harvests the plants growing in the cultivating pot member 30, which goes through the chain gear 22, as standing state in front of the left and right horizontal beam 132 as described hereinafter.

In addition, in each corresponding place where the chain 23 passes through in the inner sides of the front vertical beam 131, the left and right of rear vertical beam 133, and the left and right vertical beam 134, guide rails 14 is fixed and installed horizontally, thereby supporting the chain 23. Thus, there is no the chain troubles such that the chain 23 is drooped due to their weight or jumped their moving path.

On the other hand, the diameter of each chain roller 231 of the chain is larger than the upper and the bottom width of an inside and outside plates 232, then the inside and outside plates 232 are rotating and moving by touching the outer surface of the chain roller 231 to the bottom of the guide rails 14, without touching the guide rails 14, as shown in FIG. 7.

In this manner, the circulation of the chain is smoothly performed because the frictional resistance does not occurred, and the abrasion, the occurrence of noise or reduced life are prevented, since the chain 23 rotates and moves as touching the outer surface of the chain roller 231 to the bottom of the guide rails 14 in course that the chain 23 goes through with the supporting state by the guide rails 14.

And, a rail groove 141, accepted of the outer surface of the chain rollers 231, is formed with a predetermined depth. When the chain roller 231 is rotated and moved as supporting by the rail groove 141, the chain 23 can be moved in a stable state without leaving the guide rail, even if the weight of the cultivating pot member 30 is loaded in a hook axis 26.

In addition, a roller rail 14′ is integrally and downwardly formed to be extended in the inner end of the lower surface of the guide rail 14, and a roller 233 rotated and moved with the state as the roller rail 14′ is supported in the left and right surface of the cultivating pot member 30.

Likewise, the roller 233 and the chain rollers 231 are smoothly rotated and moved, because the weight of the cultivating pot member 30 is distributed the roller 233 and the hook axis 26. Thus, the cultivating pot member 30 and the chain 23 are circulated with more stable state.

In addition, a front and rear of horizontal support beam 137′ is fixed and installed to be traversed in left and right in each corresponding portion of inner sides of the left and right vertical support beams 137 which is corresponding to the place of passing through the lower surface of the cultivating pot member 30, and a holding rail 15 is horizontally installed to be traversed in back and forth in the upper left and right of horizontal support beam, and thereby holding and supporting the lower surface of the cultivating pot member 30. Thus, the horizontal valence is easily maintained and the load is dispersed over the holding rail 15 without concentrating on the left and right chains 23 and the rollers 233.

And, the holding rail 15 can be more smoothly moved in result of decreasing the friction force to the maximum, since a holding plate 151, which is a relatively thin formed and molded by resin, is vertically combined on the upper end and is connected with the lower surface of the cultivating pot member 30. Also, the holding rail 15 can be simply replaced with new one when it is worn out due to the long-term use.

On the other hand, an output axis of the reduction motor 21 is connected with the axis installed to be traversed in left and right in the lower side of the left and right of rear vertical beams 133 from each axises 24 in this embodiment, but it is not necessarily limited to the present embodiment, while it is allowable that the output axis of the reduction motor 21 is connected with any axis from each axises 24.

In addition, a tension member 27 is installed on the appropriate location, preferably passing through the chain gear 22 installed the axis 24 connected with an output axis of the reduction motor 21, in the moving path where the chain 23 is circulated, so that the tension member 27 can be hold and supported the chain 23 to prevent from drooping.

The cultivating pot member 30 includes a can body 31 having an opening in the upper surface, a “∩” type hook plate 32 for fixing the upper both ends of the can body respectively, and a cover plate 33 combined to the opening to be covered the upper surface and formed with a coupling hole 331 of a plant pot 30a.

The can body 31 is vertically and lengthily formed, the hook plate 32 is integrally formed on the upper surface of each fixing plate 321 which is adhered to be covered on the opened upper both ends of the can body, then the cultivating pot member 30 can be put on the left and right chains 23 as hang from the chains with constant interval as described hereinafter.

A cover plate 33 is formed to be proportional to the length between the fixing plate 321 which is adhered to be covered on the opened upper both ends of the can body, and the coupling hole 331 are formed with the appropriate numbers at regular intervals considering the diameter of the plant pot 30a.

Each plant pot 30a is combined onto these coupling holes 331, the rest part, except the upper part putted on the coupling hole 331, is immersed in medicinal fluid received in the can body 31, thereby supplying nutrient to the plants.

In addition, the cover plate 33 can be simply and easily combined, or separated onto the upper surface of the can body, since a combing part 311 is recessed and formed in length direction on the front or rear of the upper end of the can body 31 and a combing plate 332 for combining to the combing part 311 is downwardly extended in the front and rear ends of the cover plate 33.

On the other hand, a hold plate 34 can be attached or detached in the can body 31 to hold or support plants of which stem can be spread such as strawberry.

To this end, a binding part 312 is recessed and formed in length direction on the front or rear of the upper end of the can body 31, and a binding plate 341 for combining or separating the binding part 312 is downwardly extended for length direction in one end of the hold plate 34 which is corresponding to the binding part 312.

This holding plate 34 includes an end where a binding plate 341 is horizontally formed and the other end extended and formed to be obliquely downward as the angle is smoothly gone down toward the other end to naturally hold to spread stem.

And, a gauge 35 is vertically penetrated and installed on an installation hole formed in any fixing plate among the fixing plates 321, so that the user can always check the medicinal fluid level accommodated in the can body 31. As the result, the medicinal fluid supplier 40 can supply the medicinal fluid when the medicinal fluid is insufficient, while can stop the supply immediately when the medicinal fluid is reached to appropriate level.

In addition, since a grouting 333 is formed in the middle of the cover plate 33, the medicinal fluid supplied by the medicinal fluid supplier 40 can be injected to the can body through the grouting 333 in the state that the cover plate 31 is coupled to the upper surface of the can body 31.

In addition, a separation plate 36 formed with the grouting 333 is fixed in the middle of the opened upper surface if the length of the can body 31 is longer, and the cover boards 33 formed with a separated length are combined in the opened upper surface separated in left and right by the separation plate 36, respectively.

These structure is intended to prevent from deforming the cover plate 33 by the load, while the number of coupling holes 331 will be increased to combine with a plurality of plant pots 30a in the case that the cover plate 33 is formed with same length as having long length of the can body 31.

To install the cultivating pot member 30 on the circulatory system 20, each vertical portion of a “ [symbol] ” shaped bracket 25 with a constant interval in the inner space of the left and right chains 23 which is faced each other, and hook axises 26 are horizontally fixed and installed in each horizontal portion.

Thus, when the cultivating pot member 30 is installed in the circulatory system 20, the upper end of the hook plates 32 are axis-coupled to the hook axis 26 horizontally adhered to the inner surfaces of the left and right chains 23, respectively, thereby easily installing the cultivating pot member 30 between the chains with the constant interval as hanging state onto the chains. At this stage, the reduction motor 21 is driven to rotate the chain, the cultivating pot members 30 are moved and circulated along to “ [symbol] ” shaped path in the inner space of the cultivation room 10.

As described as above, the cultivating pot member 30 can be moved with hanging onto the chains to be maintained the weight balance by dead load, because the upper end during in the process of moving circulation, formed in the curved surface of the hook plate 32, is axis-combined and installed as hanging onto the hook axis 26. Thus, the cultivating pot member 30 can be maintained the balance in course of passing through each chain gear 22.

This circulated operation for the cultivating pot member 30 is to equally supply sun light onto the plants potted in each plant pot 30a, and the circulated speed is controlled by the control operation of the reduction motor 21.

Meanwhile, in the embodiment of the present invention, the upper end of the cultivating pot member 30 are hanged onto the hook axis 26 by using the “∩” type hook plate 32, it does not necessarily limited to this, while a hook plate, of which an end is formed in a tube type, can be also installed.

In addition, in the embodiment of the present invention, it is described that the cover plate 33 is formed to onto the opened upper surface of the can body 31 and the gauge 35 is installed onto the upper end of fixing plates 321, respectively. Here, it is desired that the cultivating pot member 30 is to use the plants cultivating with the medicinal fluid. But, when the user want to cultivate the plants growing in the soil such as strawberries, the user does not install the cover plate 33 and the gauge 35, but puts the cusandy loam 37 into the lower part of the can body 31, and puts the culture soil 38 with an appropriate thickness on the upper surface of cusandy loam 37, and then transplants strawberry seedlings at required intervals as shown in FIG. 11.

Here, the cusandy loam 37 and the culture soil 38, etc. are all sterilized to prevent the occurrence of the insect, and the cusandy loam 37 militates to supply the medicinal fluid into the can body 31 as soon as possible.

And a drain aperture 314 is formed on the lower end of the can body 31, an waterspout 16 is installed to be traversed toward back and forth in each corresponding location of the inner side of the left and right vertical support beams 137 which is corresponding to the drain aperture 314.

When the medicinal fluid is supplied into the cultivating pot member 30 using the cusandy loam 37 and the culture soil 38, and it is preferable that the medicinal fluid supplier 40 is activated and supply the medicinal fluid from an upper surface of the cultivating pot member 30 where the binding plate 341 is not formed, so that the medicinal fluid can wet from the upper part of the cusandy loam 37 to the lower part of the culture soil 38 in vertical direction.

If the lower portion of the cultivating pot member 30 is wetted with the medicinal fluid, some of the medicinal fluid will be drained through the drain aperture 314 and flowed down the waterspout 16, thereby confirming that the medicinal fluid is sufficiently supplied without the gauge 35. Next, the user stops the cultivating pot member 30 to be discontinued the supply, then the drained medicinal fluid can be sent to a collecting tank (not shown) which is separately installed and connected with the waterspout 16 and the collected medicinal fluid can also reused.

The medicinal fluid supply 40 includes a pump 41 for pumping the medicinal fluid stored in a medicinal fluid tank (not shown); a supply pipe 42 having an end connected with the pump 41 and the other end 421 for draining from middle portion of an end of the frame 13 to the lower and inner portion; a distribution pipe 43 horizontally installed to be traversed toward back and forth in the middle and upper part of the plurality of cultivating pot members 30 connected the middle part with the other end 421 and passed through in the lowest part of the frame 13; and an inlet 44 additionally installed on the lower part of the distribution pipe 43 with an interval corresponding to the grouting 333.

As described above, to install the distribution pipes 43 to be traversed toward back and forth in the middle and upper part of the plurality of cultivating pot members 30 passed through in the lowest part of the frame 13, it is intended to minimize the sun light blocking phenomenon since the sun light will be partially shut out when the distribution pipes 43 is installed on the upper part.

If the pump 41 of the medicinal fluid supplier 40 operates and pumps the medicinal fluid stored in the medicinal fluid tank, the medicinal fluid is supplied to the inner part of the can body 31 through the supply pipe 42, the inlet 44 of the distribution pipe 43 connected with the other end 421, and the grouting 333 which is located on the downside.

The procedure of supplying the medicinal fluid to each cultivating pot member 30 will be described as below. First, the user interrupts the operation of the circulatory system 20 to stop the movement of each cultivating pot member 30. Second, the medicinal fluid supplier 40 simultaneously supplies the medicinal fluid through each the inlet 44 to the cultivating pot members 30 located on the downside of the distribution pipe 43. Third, if the supply operation is completed, the circulatory system 20 can be operated to move the cultivating pot member 30 where the medicinal fluid is supplied, so that the cultivating pot member 30 can be departed from the lower part of the distribution pipe 43. Fourth, if the medicinal fluid should be supplied, the user moves and stops the corresponding cultivating pot member, as an object for injecting the medicinal fluid, onto each the inlet 44 and then the user can repeated the procedure as many times as necessary as described above.

The water level of the medicinal fluid supplied by the medicinal fluid supplier 40 can be checked by the gauge 35 immediately, thus the user can stop the medicinal fluid supplier 40 when the appropriate amount of the medicinal fluid is supplied.

The air blower 50 includes: an air blast fan 51; a blast pipe 52 formed to be traversed toward back and forth on the lower end of the frame 13 by connecting a rear end with the air blast fan 51; a plurality of branched blast pipes 53 formed to be traversed toward left and right on the lower surface of each frame 13 by connecting the rear end to the air blast fan 51 at regular intervals; and an exhaust 54 formed at regular intervals in each upper surface of the branched blast pipes 53.

The air blower 50 drives the air blast fan 51 to selectively inhale the outside air (CO2 or O2 included) or internal air.

Since the inhaled air generated by operating the air blast fan 51 is supplied to the each branched blast pipe 53 through the blast pipe 52 and discharged from the upward to the bottom of the frame 13 through each exhaust 54, the air blast fan 51 can supply purified external air or circulate internal air to each cultivating pot member 30. Thus, it is smoothly performed to adjust the internal temperature, supply the fresh air, and adequately ventilated with clean wind, thereby constructing a pleasant environment. Also, the plants can be grown and cultivated in the pleasant environment such that the growth and development is expedited as well as the rotting for the plants and fruits are prevented simultaneously.

Meanwhile, in the embodiment of the present invention, it is desirable to install a lamp 60 to provide enough sun light energy during all-weather onto the vulnerable area which is not sunny location, that is, in the lower part except for the cultivating pot member 30 which is passing through the upper end, in case that the left and right chains 23 are passed through “ [symbol] ” type path among the front vertical beam 131, the left and right of rear vertical beam 133, and the left and right vertical beam 134.

To this end, a plurality of lamps 60 are installed onto the frame 13 at regular intervals to be traversed toward left and right for the moving direction of the cultivating pot member 30 in the corresponding area which is not sunny location, so that the user can always light on, if necessary.

Accordingly, the plants can be cultivated and harvested in a short period in all weather without not only a significant impact on the natural environment but also regardless of place for cultivation, since the plants potted in plant pots 30a can be evenly received the sun light energy regardless of the location where the cultivating pot member 30 is moved.

In embodiment of the present invention, the forth and back intervals where the cultivating pot member 30 is circulated, or the left and right intervals between the plurality of the cultivating pot members 30 can be determined within the range beyond the growth by considering the plant's characteristics.

In other words, if the user want to cultivate plants, of which stems grown and extend to the horizontal directions, such as strawberries, the left and right intervals between the plurality of the cultivating pot member 30 should be broaden than the forth and back intervals, while if the user want to cultivate plants, of which stems grown and extend toward upward, such as, lettuce or Chinese cabbage, the forth and back intervals should be broaden than the left and right intervals.

The left and right intervals can be adjusted by selecting and hooking the number of the cultivating pot member 30 onto the hook axis 26 fixed to the left and right chain 23 at regular intervals, while the forth and back intervals can be also adjusted by controlling the size of the diameter of the chain gear 22 for pinning the left and right chain 23.

In addition, the frame 13 can be stably moved, since the wheels are installed in the bottom of the frame 13 and the guide rail is also installed onto the ground.

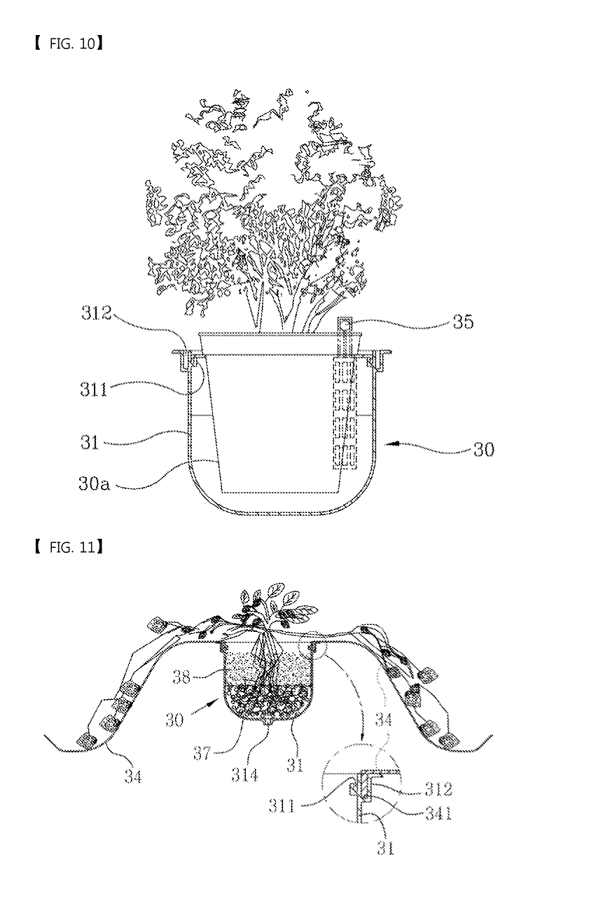

FIG. 12 is a side view of schematically illustrating a plant cultivation system in accordance with the second embodiment of the present invention, FIG. 13 is a front view of illustrating specific part in FIG. 12.

The plant cultivation system of the second embodiment of the present invention is characterized in that, the cultivating pot member 30 can be both ascended or descended toward forth and back, and horizontally circulated. To achieve this, the frame 13 is installed so that a plurality of short vertical beams 139 and the left and right vertical beams 138, which are longer than the short vertical beams 139, are installed and arranged by turn onto the left and right horizontal beams 132.

In addition, the plurality of left and right chain gears 22 are axis-fixed onto each left and right ends of the plurality of axises 24 installed to be traversed toward left and right for the upper end of the left and right vertical beams 138 and the upper and lower ends of the left and right horizontal beams 132 located in the upper end and lower end of the short vertical beams 139, while the left and right chains 23 is chained on the chain gear by turn, respectively.

As the left and right chains 23 is chained as described above, the left and right chains 23 can be horizontally moved in the space of the chain gears 23 axis-installed in the forth and back of the left and right horizontal beams 132, while the left and right chains 23 can be ascended and descended repeatedly as passing through the upper ends of both the left and right vertical beams 138 and the short vertical beams 139 by turn.

Accordingly, if the plurality of cultivating pot members 30 are hooked by hanging the hook plate 32 onto the hook axis 26 fixed to the left and right chains 23 at regular intervals, the cultivating pot members 30 are slantly ascended and descended repeatedly and then horizontally moved and circulated repeatedly in the internal space of the cultivation room 10.

According to the second embodiment of the present invention, there are advantages that all part of the cultivating pot members 30 can be evenly received sun light, as compared with the first embodiment of circulating along to “ [symbol] ” path, since the intervals between the neighbored cultivating pot members 30 is more wider as slantly ascending and descending repeatedly. Also, the number of the lamp 60 can be significantly reduced as compared with the first embodiment.

And, the distribution pipe 43 conducted the other end 421 of the supply pipe 42 for supplying the medicinal fluid may be horizontally installed to be traversed toward forth and back in the middle upper portion of the plurality of can body 31 which is passed through the lowest part of the frame 13.

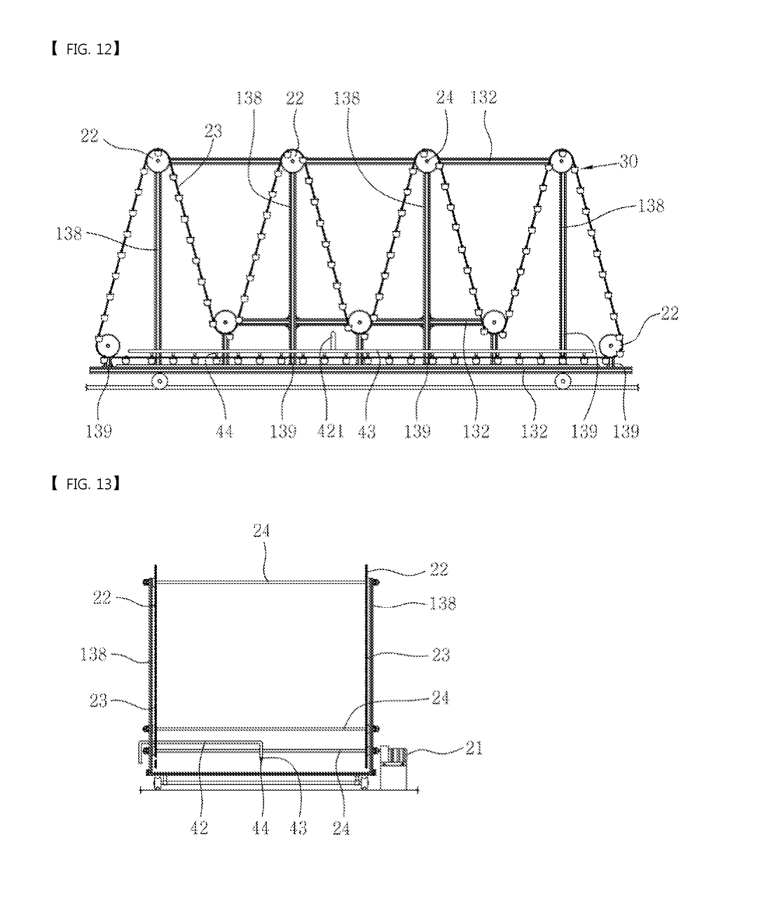

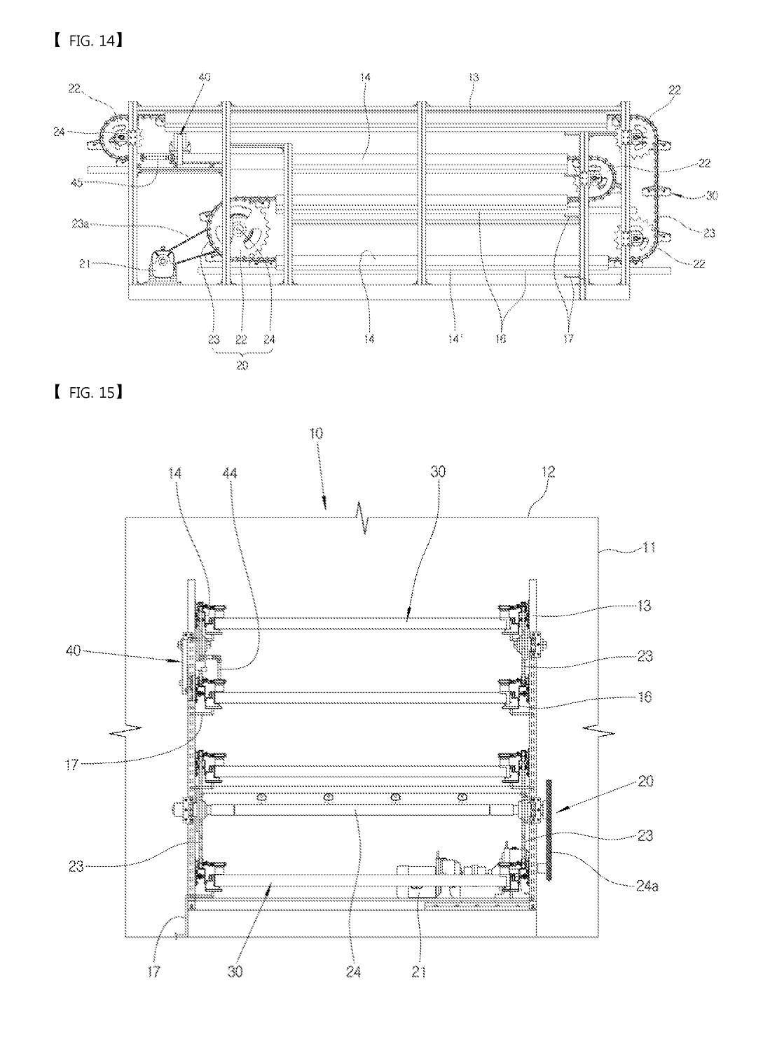

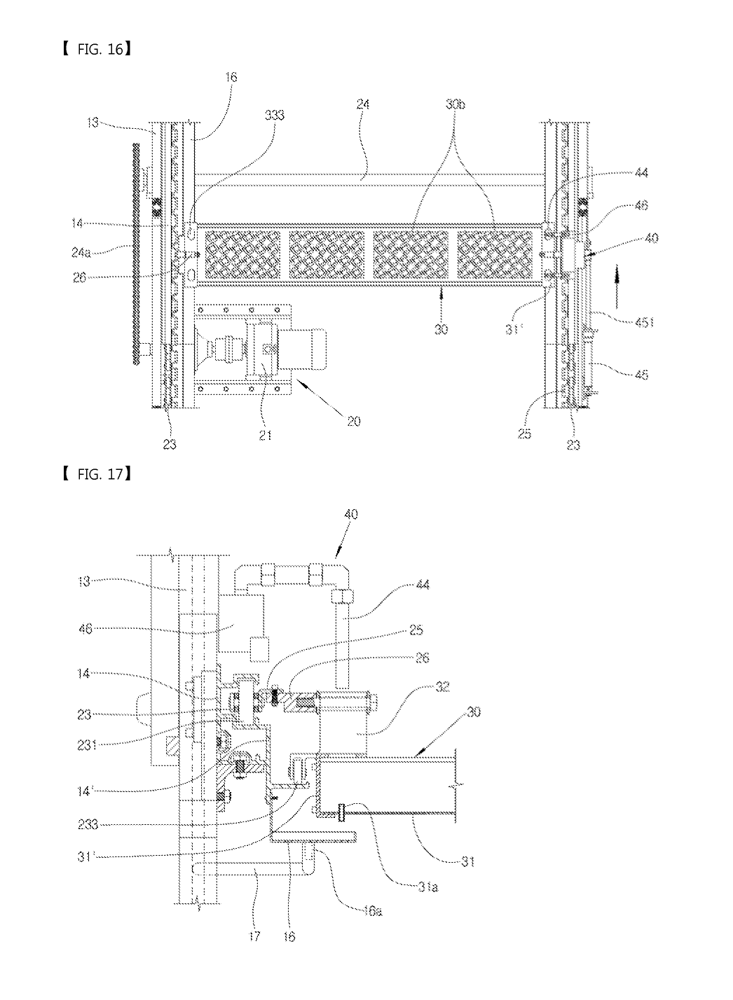

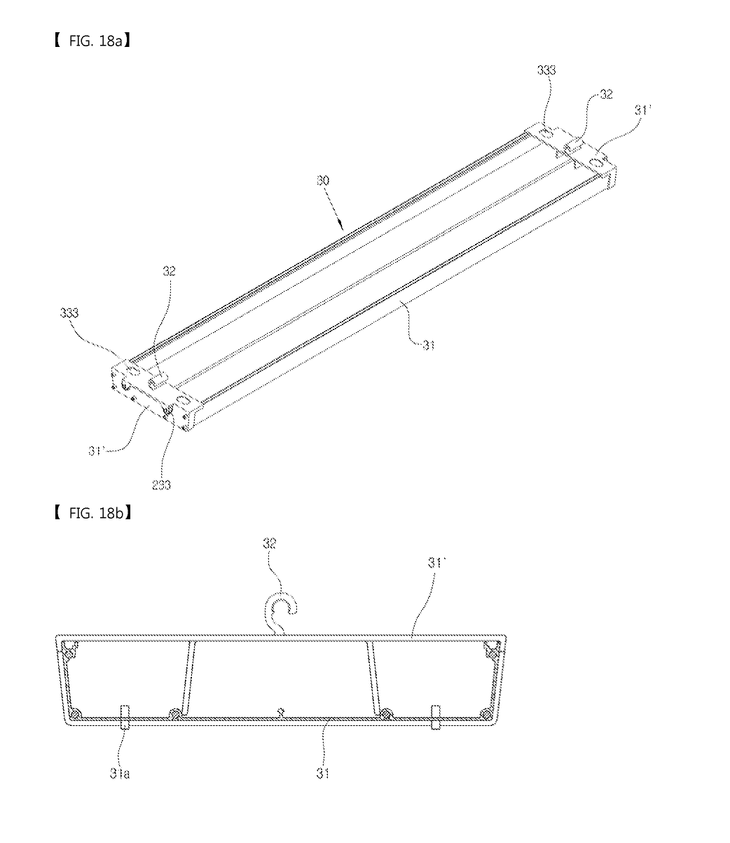

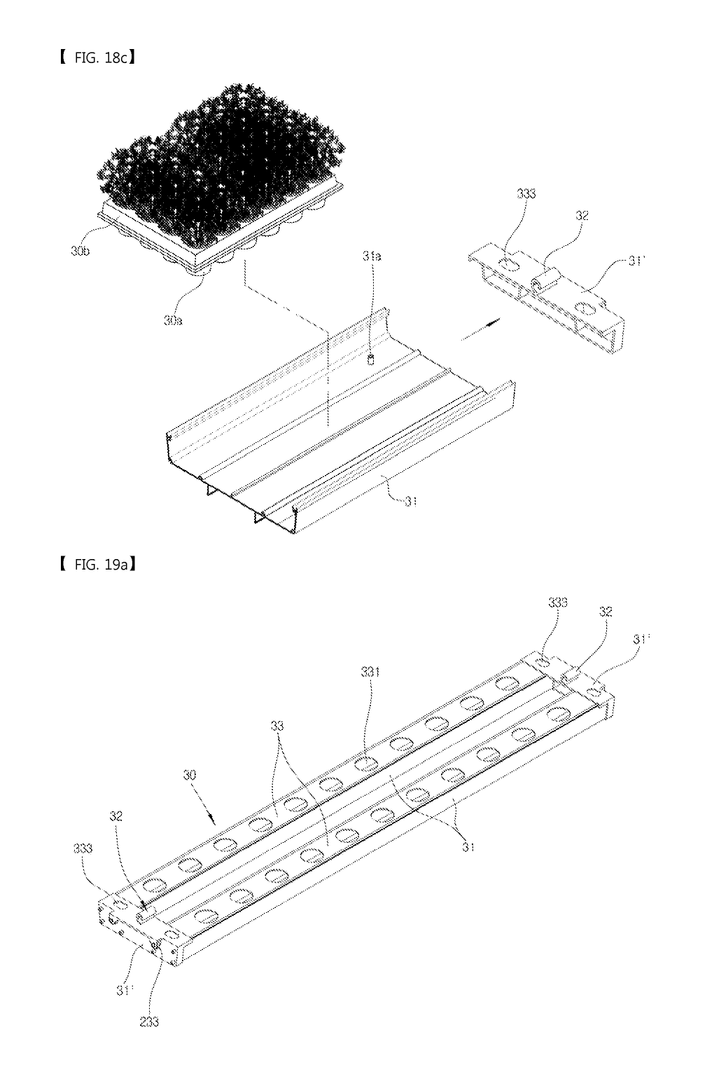

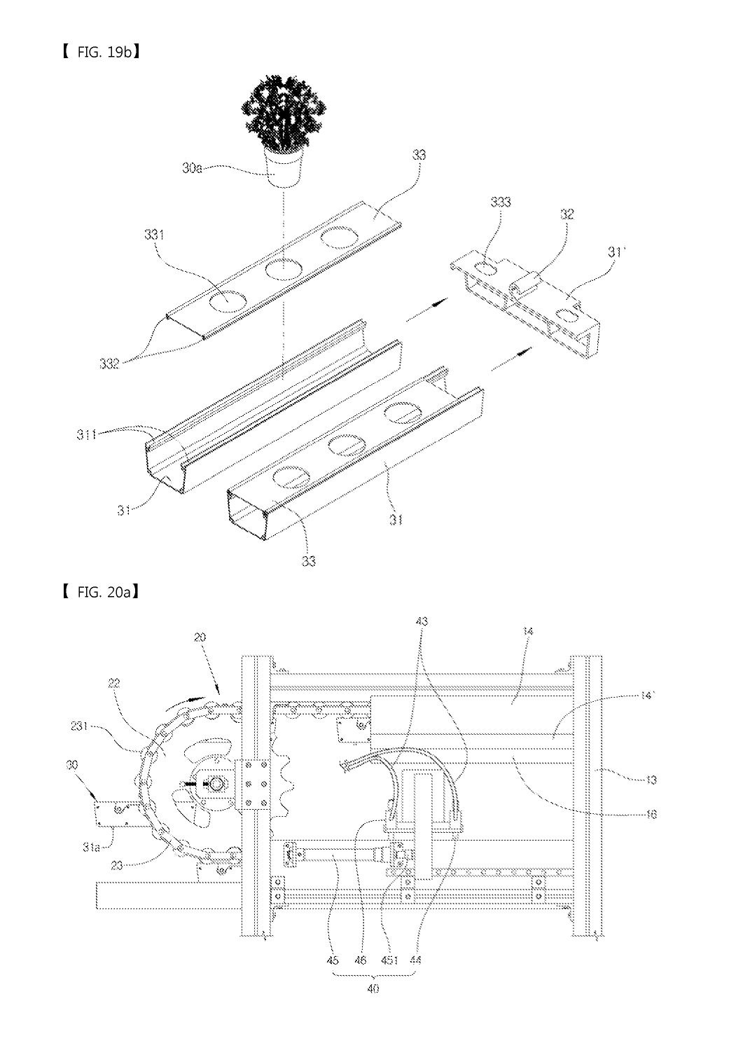

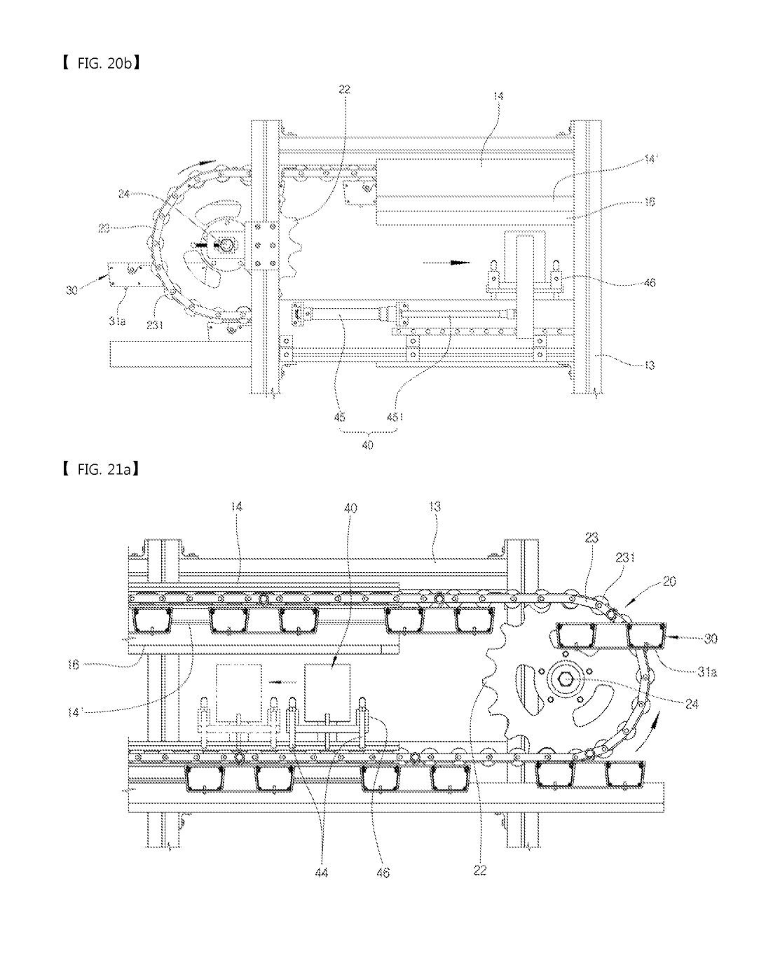

FIG. 14 is a side view of schematically illustrating a plant cultivation system in accordance with the third embodiment of the present invention; FIG. 15 is an enlarged rear view of illustrating a plant cultivation system of FIG. 14; FIG. 16 is an enlarged plane view of illustrating a main part of a plant cultivation system of FIG. 14; FIG. 17 is an enlarged rear view of illustrating a main part of a plant cultivation system of FIG. 14; FIG. 18a is an enlarged perspective view of illustrating a cultivating pot member in FIG. 14; FIG. 18b is an enlarged side view of illustrating a cultivating pot member in FIG. 18a; FIG. 18c is a separated perspective view of illustrating a main part of a cultivating pot member in FIG. 18a; FIG. 19a is a perspective view of illustrating other example of a cultivating pot member applied in FIG. 14; FIG. 19b is an enlarged perspective view of illustrating a main part of a cultivating pot member of FIG. 14; FIG. 20a is an enlarged side view of illustrating a main part of a medicinal fluid supplier in FIG. 14; FIG. 20b is a side view of illustrating a state that a cylinder is forwardly operated in FIG. 20a; FIG. 21a is an enlarged side view of illustrating a main part of a medicinal fluid supplier in FIG. 20a; and FIG. 21b is a side view of illustrating the operation state of a medicinal fluid supplier in FIG. 21a.

The plant cultivation system of the third embodiment of the present invention includes: a cultivation room 10; a circulatory system 20 which is installed on the inside of the cultivation room; a plurality of cultivating pot members 30 arranged with a constant internal in the circulatory system 20 to rotatably move the internal space of the cultivation room 10; and a medicinal fluid supplier 40 for providing medicinal fluid to the plurality of cultivating pot members 30.

The cultivation room 10 is constructed with four walls 11 and ceiling 12 by using vinyl, transparent plastic boards, acrylic resin, or glass etc. such as a typical glass greenhouse or vinyl greenhouse, and a door is generally installed on one wall among the four walls for cultivation and harvest management.

The circulatory system 20 includes a deduction motor 21, a plurality of chain gear 22, and a left and a right chains 23, while the plurality of chain gear 22, and a left and a right chains 23 are equipped in the frame 13 to be able to take full advantage of the internal space in view of the height or the width of the cultivation room 10 as well as the kind of plants.

The plurality of left and right chain gears 22 are installed on each axis 24 located both in the left and right lower ends of the inner upward portion and the left and right upper, middle, and lower ends of the inner backward portion of the frame 13.

And in case that the axis 24, for installing the plurality of left and right chain gears 22 in the lower part of inner upward portion, and directly receiving the driving force from the reduction motor 21, becomes a long axis traversed toward left and right in the inner space of the frame 13, while the axis 24, for installing the left and right chain gears 22 in the portion located both in the left and right upper ends of the inner upward portion and the left and right upper, middle, and lower ends of the inner backward portion of the frame 13, becomes a short axis not traversed toward left and right in the inner space of the frame 13, thereby simplifying the frame structure and reducing the installation cost.

The left and right chains 23 is chained by hanging onto the chain gears 22 located in the upward and lower portion of the frame and the chain gear located in the backward and middle portion, by hanging the chain gear located in the upward and upper portion, the chain gear located in the backward and upper portion, and the chain gear located in the backward and lower portion of the frame by turn, then passing through the chain gear located in the upward and lower portion.

According to above installation, the practical ability of the inner space will be maximized by installing a lot of cultivating pot members 30 as compared to the inner space of the cultivation room 10, since the chain 23 is chained to be horizontally moved and circulated along to “ [symbol] ” type moving path.

On the other hand, the reduction motor 21 is installed in the upward and inner lower portion of the frame 13, the left and right chains 23 can be circulated by transferring the driving force of the reduction motor 21 onto an axle, for installing the left and right chain gears in the upward and inner lower portion, by an electric chain gear and an electric chain 23a which are axis-mounted onto a driving axis of the reduction motor 21 and the left end where the left and right chain gears 22 is installed onto the upward and inner lower portion, respectively.

In addition, in each horizontal portion of left and right inner sides of the frame 13 passing through the left and right chains 23, the guide rails 14 is horizontally installed and then supports each chain roller 231 with the largest diameter of the chain.

In doing like this, since the chain 23 does not contact the guide rail 14, the circulation is smoothly performed and the noise and reduced life can be prevented due to not occur contact resistance or abrasion by the fiction.

In addition, the load of the cultivating pot member is not put onto the chain 23 and then the cultivating pot member 30 and the chain 23 can be smoothly circulated with more stable state, since the roller rail 14′ extended toward backward in the inner lower portion of the guide rail 14 can support the roller 233 installed in left and right surfaces of the cultivating pot member 30.

And, the diameter of the left and right chain gear 22, which receive the driving force of the reduction motor 21 in the inner forth and back portion, must be greater than other chain gear located in other position.

Since the chain gear 22 having large diameter decreases the number of rotations and makes strong the rotation torque in comparison with the chain gear having small diameter, the load for applying in the reduction motor 21 is minimized in the initial course for rotating the left and right chains 23 at stop state and in the process of rotating the left and right chains continuously.

Also, to install the cultivating pot member 30 in the inner portion which is facing with the left and right chains 23 each other, each vertical portion of the “ [symbol] ” type bracket 25 is fixed at regular intervals and the hook axis 26 is horizontally fixed on their horizontal portion.

The cultivating pot member 30 includes a can body 31 having an opening in the upper surface, a left and a right ends; a suture plate 31′ for bonding the left and the right ends of the can body 31 to be sutured respectively; a “∩” type hook plate 32 constructed on the middle portion of the upper surface of the suture plate 31′; and a medicinal fluid grouting 333 formed in the forth and back of the upper surface of the suture plate 31′.

The can body 31 is longitudinally formed with a long width which can move and plant the plant pots 30a as nursery 32b as it is, without separating the plant pots 30a arranged by multiple columns and rows in the nursery 32b and germinate the seeds.

Meanwhile, an overflow tube 31a is installed in any bottom surface of a left or right surface of the cultivating pot member 30 to discharge the medicinal fluid excessively supplied, and thereby maintaining always appropriated water level.

When the cultivating pot member 30 is installed in the circulatory system 20, it is desired that the upper end of the hook plate 32 can be hanged onto each hook axis 26 which is horizontally fixed to the inner surface facing with the left and right chains 23 each other.

Thus, the cultivating pot member 30 is rotately axis-installed between the left and right chains 23 on the hook axis 26 as an axis such as hanging state at regular intervals, then the cultivating pot members can be circulated along to “ [symbol] ” type moving path in the inner space of the cultivation room 10 when the reduction motor 21 is driven to be rotated the chain.

As such, the cultivating pot member 30 can slowly circulate to be not occurred that of swing back and forth by the inertia on the hook axis 26 as an axis, even if the chain 23 is stopped by stopping in the reduction motor 21.

FIG. 19a is a perspective view of illustrating other example of a cultivating pot member applied in FIG. 14; and FIG. 19b is an enlarged perspective view of illustrating a main part of a cultivating pot member of FIG. 14.

The cultivating pot member 30 is to assemble each plant pot 30a, which is separated and moved, with regular intervals one by one; and includes a forth and a back can bodies 31 having an opening in the upper surface, a left and a right ends; a left and a right suture plates 31′ for bonding and suturing by adhering the left and the right ends of the can bodies 31 on each inner surface of front and back ends of the can bodies 31; a “∩” type hook plate 32 constructed on the middle portion of the upper surface of the suture plate 31′; a cover plates 33 for covering and combining the upper surface of the forth and the back can bodies 31 in longitudinal direction, respectively; and a medicinal fluid grouting 333 formed in the forth and back portions of the upper surface of the suture plates 31′.

A combining plate 332 is downwardly extended in the front and rear ends of cover plates 33, and a coupling part 332, for combining the combining plate 332 on the upper end of the front and rear surfaces of the can bodies 31, is recessed and formed to the can bodies 31.

If the user assembles the plant pot 30a onto the coupling holes 331 of the cover plate 33 respectively, the plant pot 30a can be received the nutriment contained in the medicinal fluid provided by receiving the lower portion of the plant pot 30a, excepting the upper portion of the plant pot 30a which is hanged onto each coupling holes 331.

In addition, in any bottom surface of the left or the right surface of the can bodies 31, the overflower tube 31a is installed to discharge the discharge the medicinal fluid excessively supplied, and thereby maintaining always appropriated water level.

The medicinal fluid supplier 40 includes: a cylinder 45 horizontally installed in the upper end of the right surface of the frame 13; a supply valve 46 attached a load of the cylinder 45 and slidably installed toward forth and back; and a front and rear inlets 44 downwardly extended to the front and rear ends of the supply valve 46.

And, each one end of the distribution pipes 43 is connected with the front and rear inlets 44, where each other end is connected with the pump (not shown) for pumping the medicinal fluid stored in general tank.

In addition, the front and rear inlets 44 is adhered to the load 451 of the cylinder at intervals which is proportional to the groutings 333, directly placed on the upper position and formed in the front and rear portions of each upper surface of the suture plates 31′ sutured the opened left and right ends of the cultivating pot member 30, then the groutings 333 are directly passed through the lower portion of the front and rear inlets 44 as moving and circulating the cultivating pot members.

To supply the medicinal fluid into the medicinal fluid supplier 40, the front and rear inlets 44 are moved toward the rear direction which is an opposite direction of moving and circulating direction of the cultivating pot members and then stopped, by the load 451 forwardly driving the cylinder 45 in a state that of moving and circulating the cultivating pot members 30.

Under these conditions, the groutings 333, formed in the cultivating pot member of the cultivating pot members which are moved and circulated, are directly arrived at the lower portion of the front and rear inlets 44, i.e., at home position for receiving the medicinal fluid, and sensed by a sensor (not shown), then the cylinder 45 is reversely driven to forwardly move the load 451 of the cylinder with the same speed as the cultivating pot members which are moved and circulated and open the supply valve 46 at the same time.

Since it has completely done, in the moving course of the grouting 333 and the front and rear inlets 44 at the same speed, the medicinal fluid is passed through the supply valve 46, the front and rear inlets 44 by turn, then is supplied into the inner space of the can bodies 31 through the grouting directly located in the lower portion of the inlets 44.

The supply operation of these medicinal fluid are performed within the distance that the load 451 is forwardly moved by reversely driving the cylinder 45.

After the forward moving is completely done, the supply operation of the medicinal fluid can be repeated to supply the medicinal fluid into the next cultivating pot member 30 by forwardly driving the cylinder 45 to backwardly move the load 451 of the cylinder.

As a result, the medicinal fluid supplier 40 can supply the medicinal fluid to the cultivating pot members by turn as not stopping the moving circulation, and can stop the operation when the appropriate amount of the medicinal fluid is supplied to the all of the cultivating pot members.

On the other hand, an appropriate amount of the medicinal fluid shall be accepted into the cultivating pot members, since the amount of the medicinal fluid supplied into the cultivating pot member 30 will be increased by the operation of the medicinal fluid supplier 40, the medicinal fluid over flown into the cultivating pot member will be discharged through the overflow tube 31a.

In addition, the upper end of each outer surface of the waterspout 16 in which the upper portion is opened, is fixed and installed toward longitudinal direction in the lower end of the each guide rail 14, and then the lower end of the overflow tube 31a is located onto the opened upper end of the waterspout 16.

A drain hole 16a, formed in the rear end of the lower surface of each waterspout 16, are connected with the collecting tank through a collecting tube 17, so that the medicinal fluid drained through the overflow tube 31a is supplied into the collecting tack to reuse in the next time.

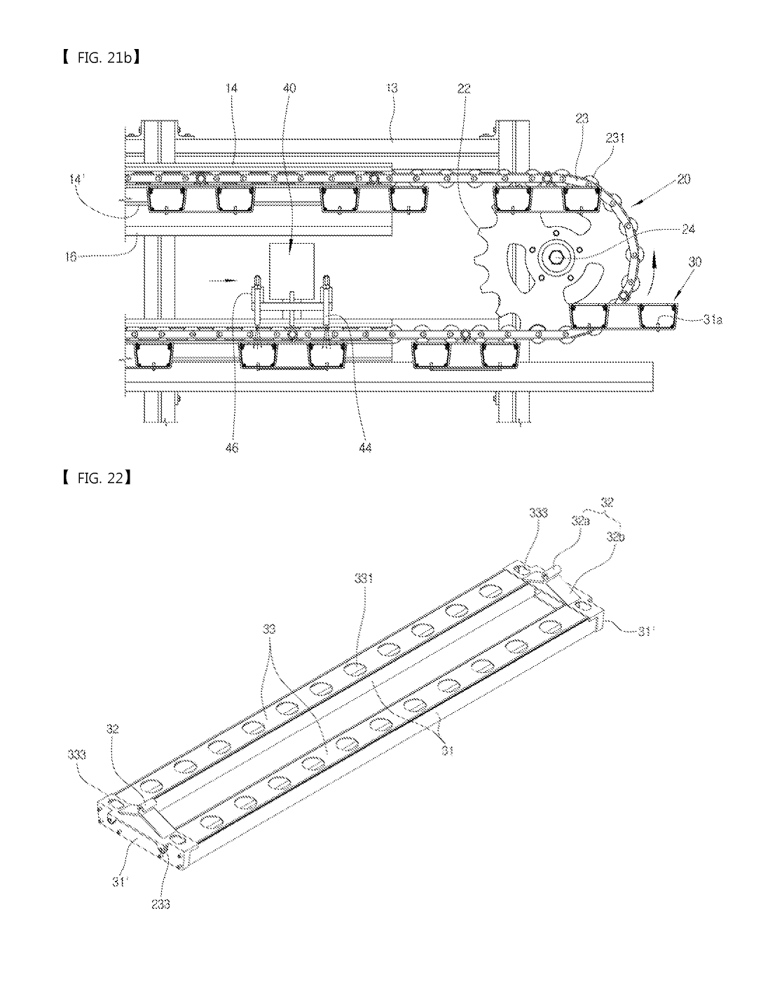

FIG. 22 is a perspective view of illustrating another example of a cultivating pot member applied in FIG. 14.

In the cultivating pot member 30 of another example, a “∩” type upper portion 32a is formed in the middle portion of the upper surface of the suture plates 31′, and a lower portion 32b downwardly extended from the upper end includes “ [symbol] ” type hook plate 32.

Accordingly, the cultivating pot member 30 can be always moved and circulated as maintaining the equilibrium state, since cases, that both the plant pots 30a are moved onto the can bodies 31, and an any side of the weight of the plant pot is more heavier centered on the upper portion 32a of the hook plate 32 hanging onto the hook axis 26, are occurred, the “ [symbol] ” type lower portion of the hook plate 32 maintains the center of the cultivating pot member to be not inclined toward forth or back direction.

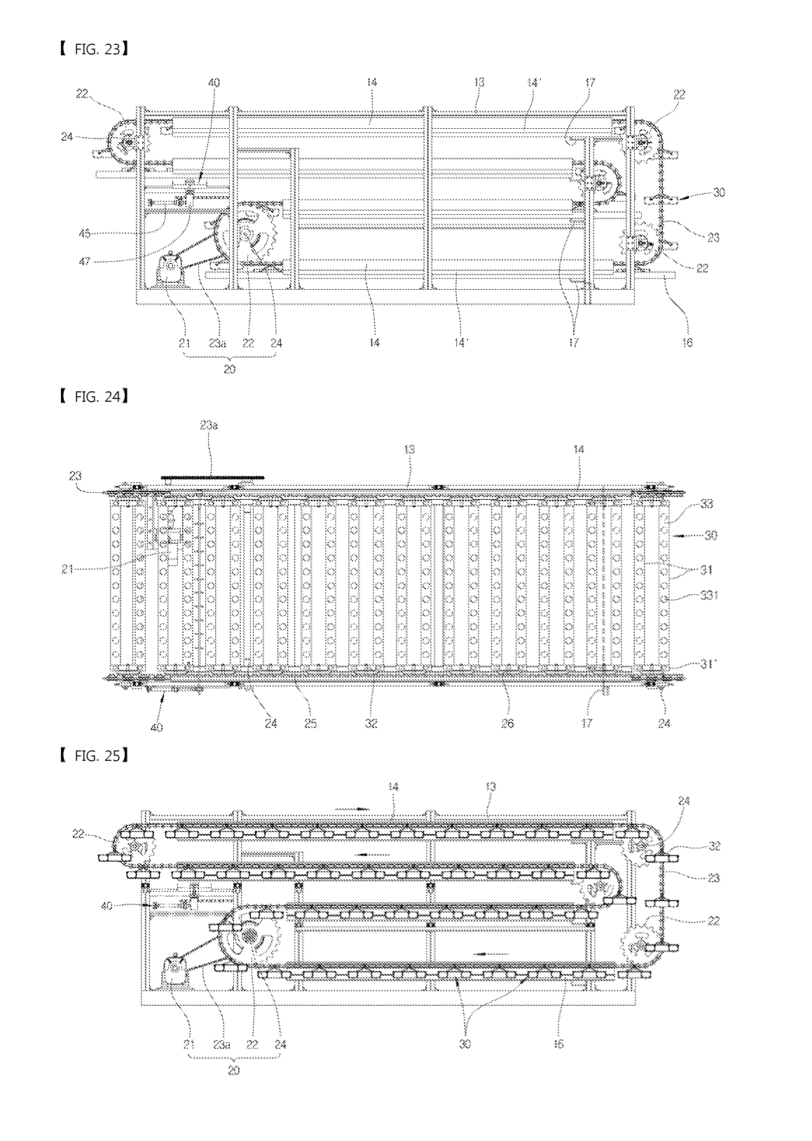

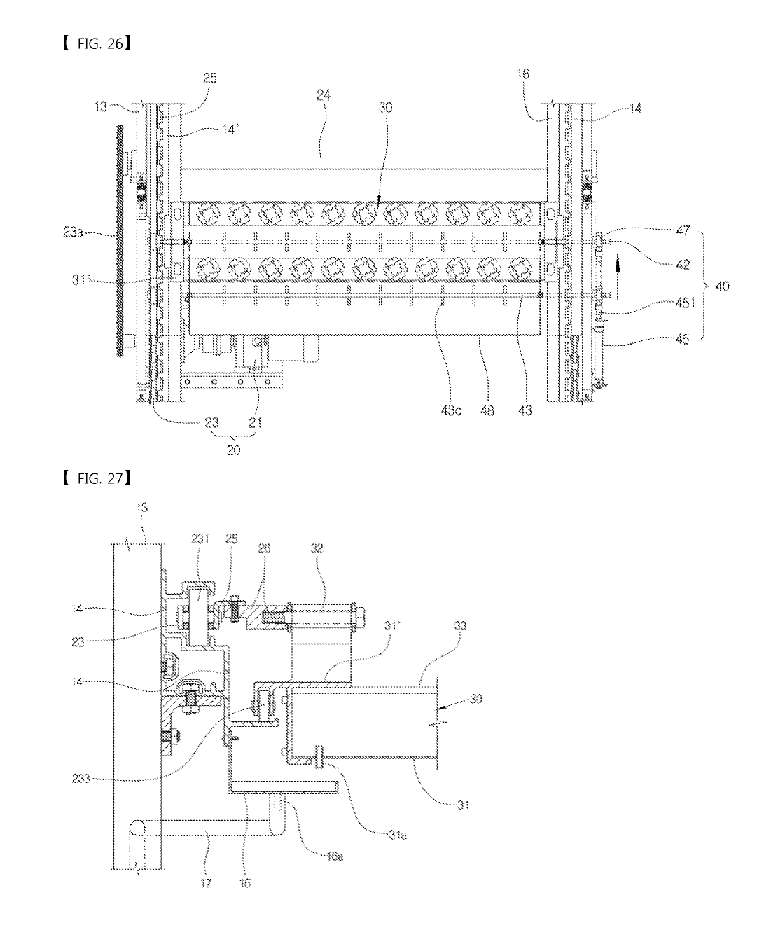

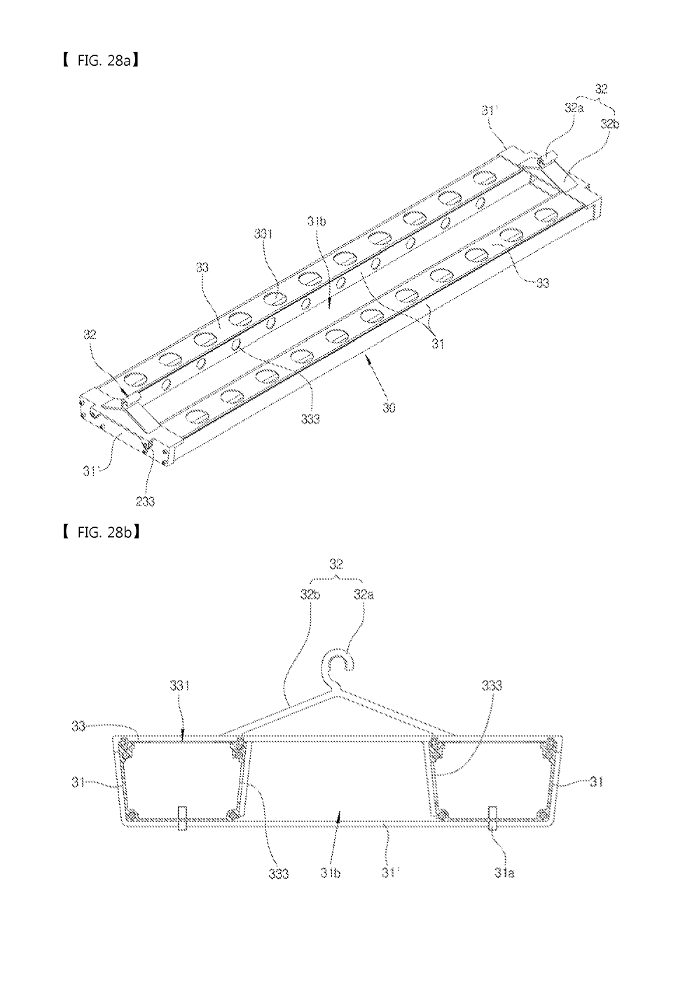

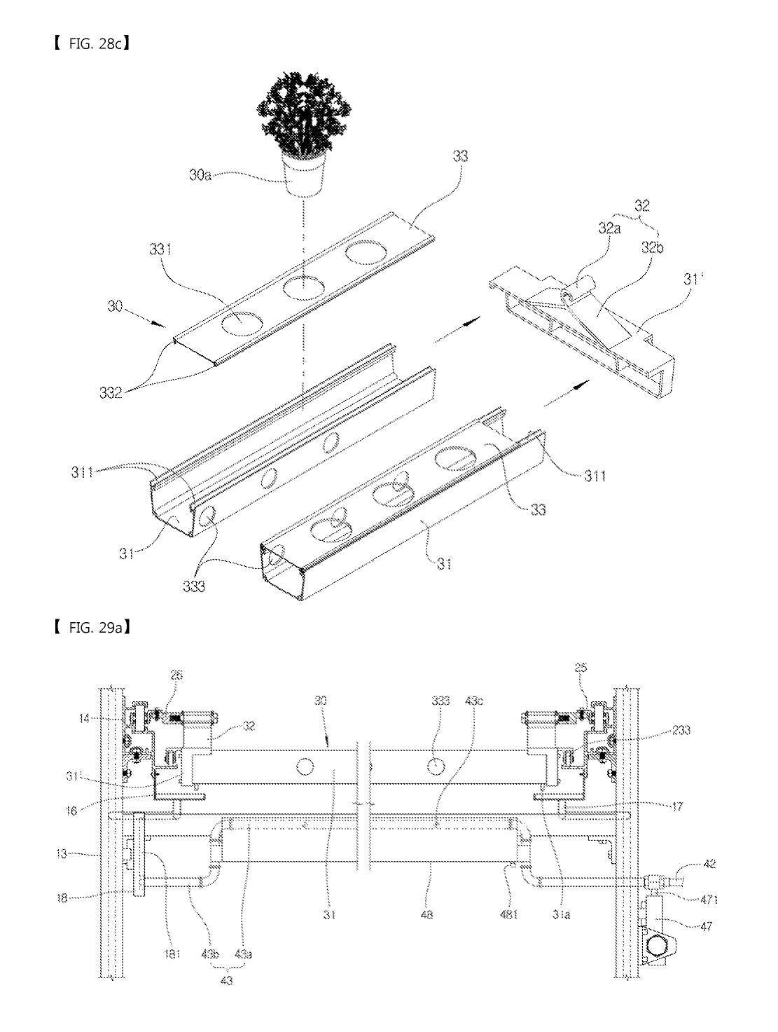

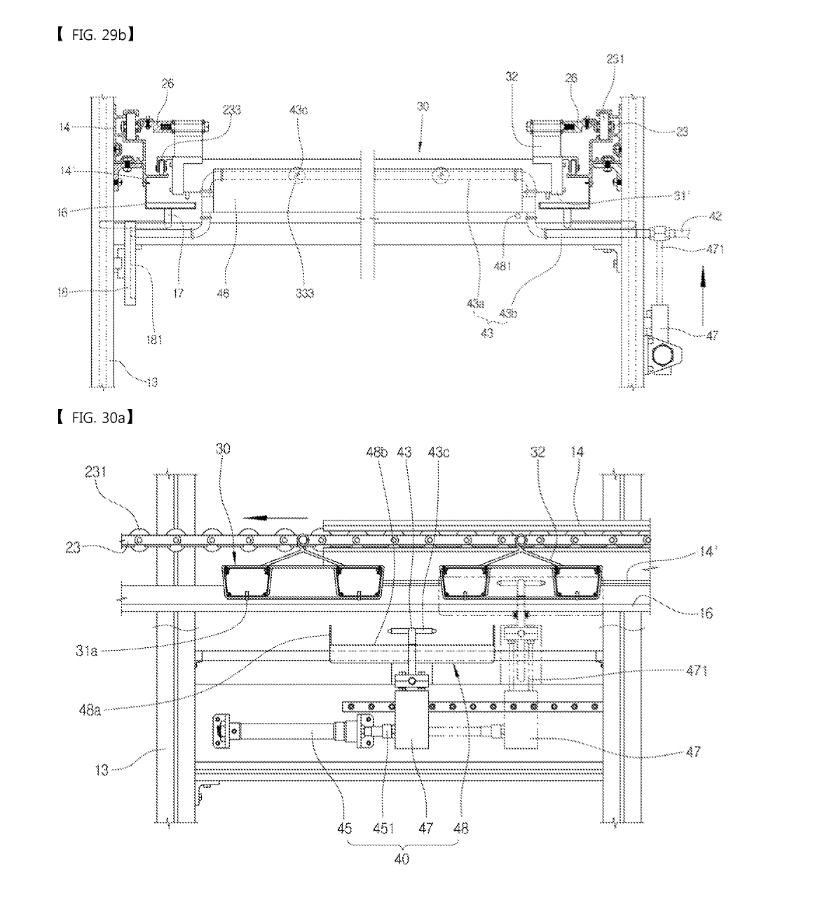

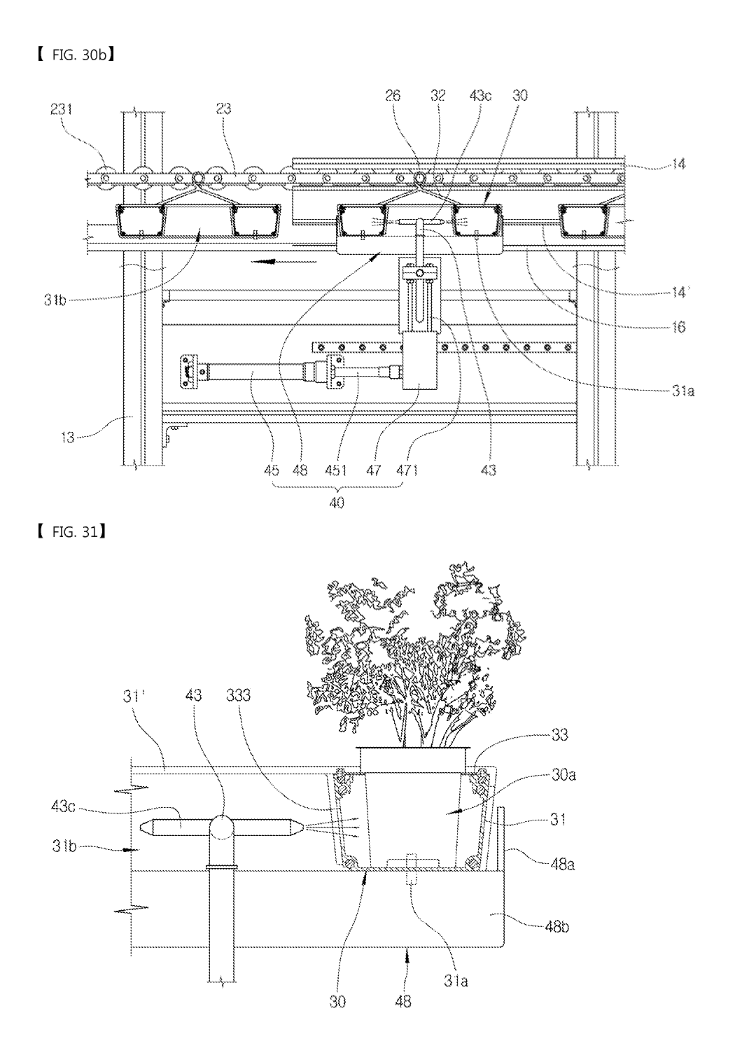

FIG. 23 is a side view of schematically illustrating a plant cultivation system in accordance with the forth embodiment of the present invention; FIG. 24 is a plane view of illustrating a plant cultivation system of FIG. 23; FIG. 25 is a side view of illustrating a main part of a plant cultivation system of FIG. 23; FIG. 26 is an enlarged plane view of illustrating a main part of a plant cultivation system in FIG. 24; FIG. 27 is an enlarged rear view of illustrating a main part of a plant cultivation system in FIG. 24; FIG. 28a is an enlarged perspective view of illustrating a cultivating pot member in FIG. 24; FIG. 28b is an enlarged side view of illustrating a cultivating pot member of FIG. 28a; FIG. 28c is an enlarged and separated perspective view of illustrating a main part of a cultivating pot member in FIG. 28a; FIG. 29a is an enlarged plane view of illustrating a main part of a medicinal fluid supplier in FIG. 24; FIG. 29b is a plane view of illustrating a state that a cylinder is forwardly operated in FIG. 29a; FIG. 30a is an enlarged side view of illustrating an installation place of a medicinal fluid supplier in FIG. 29a; FIG. 30b is a side view of illustrating the operation state of a medicinal fluid supplier in FIG. 30a; and FIG. 31 is an enlarged sectional view of illustrating a state that medicinal fluid is supplied to a cultivating pot member in FIG. 30a.

The plant cultivation system of a fourth embodiment of the present invention includes: a cultivation room 10 formed in four walls and ceiling by using vinyl, transparent plastic boards, acrylic resin, or glass etc. such as a typical glass greenhouse or vinyl greenhouse, and a door generally installed on one wall among the four walls for cultivation and harvest management; a reduction motor 21; a plurality of left and right chain gears 22; and a plurality of left and right chains 23. The circulatory system 20 is constituted the same as the third embodiment of the present invention and includes a deduction motor, a plurality of chain gear, and a left and a right chains, which are equipped in a frame 13 to be able to take full advantage of the internal space in view of the height or the width of the cultivation room as well as the kind of plants. However, the cultivating pot member 30 and the medicinal fluid supplier 40 are differently constituted in comparison with the third embodiment of the present invention.

The cultivating pot member 30 includes a couple of forth and back can bodies 31, a suture plates 31′, and a forth and back cover plates 33.

The couple of forth and back can bodies 31 formed narrowly in width and lengthily in length and includes: an upper surface, a left and a right ends which are opened; a couple portion 311 recessed and lengthily formed onto the upper end of forth and back surfaces of the can bodies; and a medicinal fluid grouting 333 formed in the middle portion of any surface of the forth and back surfaces at regular intervals.

These can bodies 31 is fixed and installed in the opened left and right ends by suturing and combining with the inner forth and back of the suture plates 31′, so that the medicinal fluid is not spilled to the outside. In this stage, a pathway 31b for penetrating in above and below can be formed in longitudinal direction between the can bodies which are separated in forth and back.

At this time, the medicinal fluid grouting 333, formed in the middle portion of any surface of the forth and back surfaces of the can bodies 31, is used to fix and install the left and right ends into the suture plates 31′ to be faced each other.

Accordingly, the medicinal fluid pumped is supplied into the inner space of the forth and back can bodies 31 through nozzles 43a and the groutings 333 at the same time, by squaring the nozzles 43a, formed in front and rear surfaces of a horizontal portion 43a of the distribution pipe 42, with the groutings 333 of the forth and back can bodies 31 when the horizontal portion 43a is risen from the lower portion through the pathway alb since the medicinal fluid supplier 40 is operated.

And, in the middle portion of the upper surface of the suture plates 31′, the hook plate 32 is installed while an upper portion 32a is formed in “∩” shape and a lower portion 32b, downwardly extended from one end to the other end of the upper portion, is formed “ [symbol] ” shape.

If the user hangs the hook plate 32 onto hook axis 26 fixed in the inner surfaces of the left and right chains 23 faced each other at regular intervals, then the cultivating pot members can be hangingly installed to be horizontally traversed between the left and right chains.

In addition, in the exterior of the suture plates 31′, the roller 233 supported in a roller rail 14′ downwardly and integrally extended to the inner lower end of the guide rail 14. Thus, the weight of the cultivating pot member 30 is not loaded on the left and right chains 23 and then the cultivating pot members and the chain are smoothly moved and circulated at stable state.

The cover plate 33 is to cover and combine the upper surface of the forth and the back can bodies 31 in longitudinal direction, respectively, and a combining plate 332 combined in the combining plate 332 is downwardly extended in the forth and back ends of cover plates, and a coupling hole 331 of the plant pot 30a is formed in the upper surface at regular intervals.

Accordingly, the cultivating pot member 30 can be always moved and circulated as maintaining the equilibrium state, since cases, that both the plant pots 30a are coupled onto the coupling holes 331 of each cover plate 33 respectively, and an any side of the weight of the plant pot is more heavier centered on the upper portion 32a of the hook plate 32 hanging onto the hook axis 26, are occurred, the “ [symbol] ” type lower portion of the hook plate 32 maintains the center of the cultivating pot member to be not inclined toward forth or back direction.

Meanwhile, the medicinal fluid supplier 40 of the forth embodiment of the present invention is installed in the middle portion of the front surface of the frame 13 and includes: a distribution pipes 43, a cylinder 45, a vertical cylinder 47 and a collecting tank 48.

The distribution pipes 43 includes a horizontal portion 43a, left and right ends 43b double strained from both ends of the horizontal portion to the lower vertically and extended to horizontal direction, and nozzles 43c horizontally formed in the front and rear surfaces of the horizontal portion at regular intervals.

The left end of the left and right ends 43b of the distribution pipes 43 is combined into a guide groove 181 vertically formed in the inner side of the guide plate 18 located in the left side of the frame in order to vertically ascend or descend, while the right end is fixed and installed on the upper end of the load 471 of the vertical cylinder 47.

Accordingly, since the vertical cylinder 47 is forwardly driven, and the load 471 can vertically ascend, then the distribution pipes 43 are horizontally ascend. But the vertical cylinder 47 is reversely driven, and the load 471 can vertically descend.

And the right end of the distribution pipes 43 is connected with the supply pipe 42, which is also connected with the pump (not shown) for pumping the medicinal fluid stored in the medicinal fluid tank (not shown), so as to receive the medicinal fluid, while the left end is sealed to not spill the medicinal fluid.

The collecting tank 48 is formed in a rectangular, of which the upper surface is opened, and the left and right surfaces 48b are lower than the front and rear surfaces 48a in height. The length between the left and right surfaces is some smaller than the interval between the left and the right of the cultivating pot member 30, while the length between the front and the rear surfaces is some larger than the interval between the front and the rear of the cultivating pot member.

Accordingly, if the collecting tank 48 is ascend and next stopped, the left and right ends of the lower portion of the cultivating pot member is exposed to the outside of the left and the right surfaces of the collecting tank 48 and while the front and rear ends of the lower portion of the cultivating pot member is accepted between the front and rear surfaces of the collecting tank 48. Here, the collecting tank 48 is ascend as likely that the upper end of the left and the right ends 48b, which is more lower than the front and the rear surfaces 48a in height, can support the left and the right portions of the lower surface of the cultivating pot member in the lower portion of one cultivating pot member 30.

In doing like the above disclosure, there is exist the medicinal fluid partially overflown in the medicinal fluid supply course, the medicinal fluid can be collected into the collecting tank 48 without spilling to the outside, since both the medicinal fluid groutings 333 formed in the front and rear can bodies 31 of the cultivating pot member 30 and the nozzles 43c installed in the distribution pipes 43 to be corresponded each other, are located in the inner space of the collecting tank 48.

In addition, the outer surface of the left and right surface of the collecting tank 48 is vertically fixed in the lower portion of the left and right ends 43b of the distribution pipes 43 to traverse toward left and right the inner upper portion through the upper ends of the left and right surface 48b where the horizontal portion 43a of the distribution pipes 43 is lower in height. And then, both the collecting tank 48 and the distribution pipes 43 can be moved in forth and back and vertically ascend or descend.

In addition, a drain hole 481 for connecting with the collecting tank through the collecting tube is installed in an end of the lower portion of the collecting tank 48, so that the medicinal fluid which is collected can be sent to the collecting tank 48.

When the medicinal fluid is supplied to the cultivating pot member 30 described as above, the cylinder 45, horizontally installed in the upper portion of the right side of the frame 13, is forwardly driven in the state that the cultivating pot members 30 having the front and rear can bodies 31 is moved and circulated, so that the vertical cylinder 47 vertically fixed and installed on the load 451 by forwardly driving the cylinder 45 installed in the upper portion of the right side of the frame 13 is moved to the reverse direction of the moving and circulating direction of the cultivating pot members 30 and stopped next, and then both the distribution pipes 43 and the collecting tank 48 can be moved in back.

Under these conditions, the pathway 31b between the front and rear can bodies 31 of the cultivating pot member for receiving the medicinal fluid among the cultivating pot members which are moved and circulated, are directly arrived at the upper portion of the distribution pipes 43, i.e., at home position for receiving the medicinal fluid, and sensed by a sensor (not shown), then (1) the cylinder 45 is reversely driven to forwardly move the load 451 of the cylinder with the same speed as the cultivating pot members which are moved and circulated and (2) the forward driving of the vertical cylinder is stopped and the medicinal fluid supplier 40 is operated at the same time in case that the horizontal portion 43a of the distribution pipes 43 is ascend to the pathway 31b by the load 471 due to forwardly drive the vertical cylinder 47, and both the nozzles 43c installed in the front and rear surfaces and medicinal fluid grouting 333 are faced each other.

Since it has completely done, in the moving course of the grouting 333 and the front and rear inlets 44 at the same speed, the medicinal fluid is passed through the supply valve 46, the front and rear inlets 44 by turn, then is supplied into the inner space of the can bodies 31 through the grouting directly located in the lower portion of the inlets 44.

The supply operation of these medicinal fluids is performed within the distance that the vertical cylinder 47 stops the forward driving and then the load 451 is forwardly moved by the reverse driving the cylinder 45.

After as soon as the forward moving is completely done, the supply operation of the medicinal fluid can be repeated to supply the medicinal fluid into the next cultivating pot member 30 by stopping the reverse driving of the vertical cylinder 47 and by forwardly driving of the cylinder 45 to backwardly move the load 451 of the cylinder in case that the distribution pipes 43 is descend completely by the load 471 since the revere driving of the cylinder 45 is stopped and the vertical cylinder 47 is reversely driven at the same time.

As a result, the medicinal fluid supplier 40 can supply the medicinal fluid to the cultivating pot members by turn as not stopping the moving circulation, and can stop the operation when the appropriate amount of the medicinal fluid is supplied to the all of the cultivating pot members.

On the other hand, an appropriate amount of the medicinal fluid shall be accepted into the cultivating pot members, since the amount of the medicinal fluid supplied into the cultivating pot member 30 will be increased by the operation of the medicinal fluid supplier 40, the medicinal fluid over flown into the cultivating pot member will be discharged through the overflow tube 31a.

In addition, the upper end of each outer surface of the waterspout 16 in which the upper portion is opened, is fixed and installed toward longitudinal direction in the lower end of the each guide rail 14, and then the lower end of the overflow tube 31a is located onto the opened upper end of the waterspout 16.

The drain holes 16a, formed in the rear end of the lower surface of each waterspout 16, are connected with the collecting tank through the collecting tube 17, so that (1) the medicinal fluid drained through the overflow tube 31a is supplied into the collecting tack, (2) and if there is exist the medicinal fluid spouting through the nozzles 43c connected with the collecting tank and rolling down into the collecting tank among the medicinal fluid supplied to the medicinal fluid grouting 333, since the drain hole 481 formed in the lower surface of the collecting tank 48 is connected with the collecting tank through a separated tube 17′ to reuse in the next time.

The plant cultivation system of the third and forth embodiments of the present invention further includes an air blast fan 51 to supply purified external air or circulate internal air, and then it is smoothly performed to adjust the internal temperature, supply the fresh air, and adequately ventilated with clean wind, thereby constructing a pleasant environment. Also, the plants can be grown and cultivated in the pleasant environment such that the growth and development is expedited as well as the rotting for the plants and fruits are prevented simultaneously.

In addition, a plurality of lamps are installed in the corresponding area which is not sunny location of the frame 13 and can be always lighted on, if necessary. Accordingly, the plants can be cultivated and harvested in a short period in all weather without not only a significant impact on the natural environment but also regardless of place for cultivation, since the plants potted in plant pots 30a can be evenly received the sun light energy regardless of the location where the cultivating pot member is moved.

In the third and forth embodiments of the present invention, the sensor which is sensed the home position of the cultivating pot member, is used light sensor or limit switch and the expression is omitted in these embodiments.

In the first through forth embodiments of the present invention, the circulatory system 20, the cultivating pot members 30, the medicinal fluid supplier 40, and the air blower 50 can be automatically operated by a general automatic control system and these can be manually operated, if necessary.

In addition, In the first, second and forth embodiments of the present invention, the cultivating pot member 30 is horizontally moved and circulated along to “ [symbol] ” path in the inner space of the cultivation room 10, while the cultivating pot member 30 is slantly ascended or descended repeatedly to move and circulate in the inner space of the cultivation room. But, this is an example that each must be described but not limited to.

The above embodiment of the claimed invention serves as illustration only, and a person skilled in the art should realize that other embodiments of the invention are possible and that the details of the invention can be modified according to various conditions of the area of the inner space in the cultivation room or the installation location as well without going beyond the concept and scope of the invention as claimed herein.

1. A plant cultivation system comprising:
a circulatory system 20 including a plurality of axises 24 installed in a corresponding portion of a frame 13 installed in a cultivation room 10; a plurality of chain gear 22 axis-installed in the plurality of axises 24 respectively; a left and a right chains 23 for chaining the plurality of chain gear 22 to be hanged by turn; and a deduction motor 21 connected and installed onto any axis of the plurality of axises 24;
a plurality of cultivating pot members 30 including a can body 31 having an opening in an upper surface, and a hook plate 32, fixed to left and right ends of the upper surface of the can body, for axis coupling and installing by hanging onto left and right hook axises 26 horizontally fixed in an inner space of the left and a right chains 23 which is faced each other at regular intervals; and for moving and circulating in the inner space of the cultivation room 10 by rotatably installing as hanging between the left and a right chains 23 by the left and right hook axises 26 and the hook plate 32;
a medicinal fluid supplier 40 for providing the medicinal fluid to the plurality of cultivating pot members 30; and
an air blower 50, installed in the cultivation room 10, for providing the filtered external air to an interior or for circulating the inner air.

2. The plant cultivation system comprising according to claim 1, further comprising a plurality of lamps 60 installed onto the frame 13 at regular intervals to be traversed toward left and right for the moving direction of the cultivating pot member 30.

3. The plant cultivation system comprising according to claim 1, further comprising a reflector 10a, installed in an inside of the cultivation room 10, for refracting sunlight shinning around the circulatory system 20 to the cultivating pot member 30.

4. The plant cultivation system comprising according to claim 1, wherein the cultivation room 10 is made of a transparent member such as vinyl, transparent plastic boards, acrylic resin, or glass etc.; and the medicinal fluid supplier 40 includes a pump 41 for pumping the medicinal fluid; a supply pipe 42 having an end connected with the pump 41 and the other end 421 for draining from a middle portion of an end of the frame 13 to a lower inner portion; a distribution pipe 43 horizontally installed to be traversed toward back and forth in the middle portion of direct upper part of the plurality of cultivating pot members 30 connected the middle part with the other end 421 and passed through in the lowest portion of the frame 13; and an inlet 44 installed on the lower portion of the distribution pipe 43 at regular intervals.

5. The plant cultivation system comprising according to claim 1, wherein the air blower 50 an air blast fan 51; a blast pipe 52 formed to be traversed toward back and forth on the lower end of the frame 13 by connecting a rear end with the air blast fan 51; a plurality of branched blast pipes 53 formed to be traversed toward left and right on the lower surface of each frame 13 by connecting a rear end to the air blast fan 51 at regular intervals; and an exhaust 54 formed at regular intervals in each upper surface of the branched blast pipes 53.

6. The plant cultivation system comprising according to claim 1, wherein the frame 13 comprises: a left and right of front vertical beam 131; a left and right horizontal beam 132 in which each rear part is fixed to the front vertical beam 131 to be forwardly extended to an outside; a left and right of rear vertical beam 133; a left and right vertical beam 134 directly located in rear place of the front vertical beam 131; a plurality of left and right horizontal support beams 135 for horizontally connecting and fixing to both an upper and a lower portions and an intermediate portion of the front vertical beam 131, the rear vertical beam 133 and the left and right vertical beam 134, and a plurality of left and right incline support beams 136 for slopingly connecting and fixing to the left and right horizontal beam 132;
the plurality of chain gears 22 are axis-fixed in the both ends of each axis 24 installed to be traversed at left and right in corresponding portions that of each upper end and lower end of the front vertical beam 131, each front end of the left and right horizontal beam 132, and each upper end, middle end, and lower end of the left and right vertical beam 134; and
the left and right chain 23 is installed to be horizontally chained and moved through a chain gear 22 located in each lower end of the left and right of front vertical beam 131, a chain gear 22 located in the upper end of the front vertical beam 131 through a chain gear 22 located in the front end of the left and right horizontal beam 132, a chain gear 22 located in the upper end of the rear vertical beam 133, a chain gear 22 located in the upper end of the left and right vertical beam 134, a chain gear 22 located in the middle end of the rear vertical beam 133, a chain gear 22 located in the middle of the left and right vertical beam 134, and a chain gear 22 located in the lower end of the rear vertical beam 133, respectively.

7. The plant cultivation system comprising according to claim 1, wherein the frame 13 includes: a plurality of left and right vertical beams 138 lengthily formed in length; a plurality of short vertical beams 139 shortly formed in length and alternately arranged one by one at regular intervals between the plurality of left and right vertical beams 138; and a plurality of left and right horizontal beams 132 for fixing the upper end and the lower end of the plurality of left and right vertical beams 138 and the plurality of short vertical beams 139, respectively;
the plurality of left and right chain gears 22 are axis-fixed onto each left and right ends of the plurality of axises 24 installed to be traversed toward left and right for the upper end of the left and right vertical beams 138 and the upper and lower ends of the left and right horizontal beams 132 located in the upper end and lower end of the short vertical beams 139; and
the left and right chains 23 where the plurality of cultivating pot members 30 is repeatedly ascended and descended toward diagonal like as vertical line between a left and right gear 22 located in the upper portion of the left and right vertical beams 138 and a left and right gear 22 located in the upper portion of the short vertical beams 139 by hanging the chain gear 22 for axis-fixing in the left and right ends of the axis 24 by turn.

8. The plant cultivation system comprising according to claim 6, wherein guide rails 14 are horizontally fixed and installed to support the chain 23 in each corresponding place where the chain 23 passes through in the inner sides of the front vertical beam 131, the left and right of rear vertical beam 133, and the left and right vertical beam 134.

9. The plant cultivation system comprising according to claim 8, wherein the diameter of each chain roller 231 of the chain is larger than the upper and the bottom width of an inside and outside plates 232, then the chain roller 231 is grounded in the bottom of the guide rails 14, and the inside and outside plates 232 is not contacted to the ground; and
a rail groove 141, accepted of the outer surface of the chain rollers 231, is formed in the upper and lower surface of the guide rail 14.

10. The plant cultivation system comprising according to claim 6, wherein the rail groove 141 for supporting the left and right chain 23 is installed in the inner side of the front vertical beam 131, the left and right of rear vertical beam 133, and the left and right vertical beam 134, while a roller rail 14′ is integrally formed to be downwardly extended in the inner end of the lower surface of the guide rail 14; and
a roller 233, rotated and moved in the state as the roller rail 14′ is supported, is axis-installed in the left and right surface of the cultivating pot member 30.

11. The plant cultivation system comprising according to claim 6, wherein a left and right vertical support beams 137 are installed in left and right ends of the front vertical beam 131, the left and right of rear vertical beam 133, and the left and right vertical beam 134; a front and rear of horizontal support beam 137′ is fixed and installed to be traversed in left and right in each corresponding portion of inner sides of the left and right vertical support beams 137 which is corresponding to the place of passing through the lower surface of the cultivating pot member 30; and a holding rail 15 is horizontally installed to be traversed in back and forth in the upper left and right of horizontal support beam 137′.

12. The plant cultivation system comprising according to claim 1, wherein the cultivating pot member 30 comprises: a can body 31 having an opening in the upper surface and a drain aperture 314 formed on the lower end; a binding part 312 excess formed in length direction in a front and rear surfaces of the upper end of the can body 31; and a holding plate 34 having an end, where a binding plate 341 is horizontally formed, to attach or detach onto the binding part, and the other end, which is downwardly and obliquely extended with slow angle from the end, is forwardly curved and formed.

13. The plant cultivation system comprising according to claim 1, wherein the cultivating pot member 30 comprises: a hook plate 32 having a “∩” type upper end for axis coupling by hanging onto the hook axis 26 and a lower end for installing a fixing plate 321 onto both ends of the upper surface of the can respectively, and a cover plate 33 combined to the opening to be covered the upper surface and formed with a coupling hole 331 of a plant pot 30a.

14. The plant cultivation system comprising according to claim 13, wherein the cultivating pot member 30 further comprises a gauge 35 is coupled and installed on an installation hole formed in a one side of the fixing plates 321.

15. The plant cultivation system comprising according to claim 1, wherein the cultivating pot member 30 comprises a can body 31 having an opening in the upper surface and vertically and lengthily formed; a hook plate 32 having a “∩” type upper end and a lower end for installing a fixing plate 321 onto both ends of the upper surface of the can body 31, respectively; a separation plate 36 formed with groutings 333 and fixed to be traversed toward left and right in the middle of the opened upper surface; left and right cover plates 33 covered and combined in the opened upper surface separated in left and right by the separation plate 36, respectively; and a gauge 35 coupled and installed on an installation hole formed in a one side of the fixing plates 321.

16. The plant cultivation system comprising according to claim 1, wherein the cultivating pot member 30 comprises a can body 31 formed lengthily in length and having an upper surface which are opened; a hook plate 32 having a “∩” type upper end and a lower end for installing a fixing plate 321 onto both ends of the upper surface of the can body 31, respectively; a separation plate 36 formed with groutings 333 and fixed to be traversed toward left and right in the middle of the opened upper surface; left and right cover plates 33 covered and combined in the opened upper surface separated in left and right by the separation plate 36, respectively; and a gauge 35 coupled and installed on an installation hole formed in a one side of the fixing plates 321;
meanwhile, the medicinal fluid supplier 40 comprises: a cylinder 45 horizontally installed in the upper end of the right surface of the frame 13; a supply valve 46 attached a load of the cylinder 45 and slidably installed toward forth and back; and a front and rear inlets 44 for injecting the medicinal fluid into the grouting 333 from directly upper side in the moving course of the grouting 333 at the same speed as the speed of the cultivating pot member 30, by installing in a forth and a back of the supply valve 46 in proportion to the intervals of the grouting 333 formed in a forth and a back of the upper surface of the suture plates 31′.

17. The plant cultivation system comprising according to claim 1, wherein the cultivating pot member 30 comprises: a forth and a back can bodies 31 having an opening in the upper surface, a left and a right ends; a left and a right suture plates 31′ for bonding and suturing by adhering the left and the right ends of the can bodies 31; a “∩” type hook plate 32 constructed on the middle portion of the upper surface of the suture plate 31′; a cover plates 33 for covering and combining the upper surface of the forth and the back can bodies 31 and formed with a coupling hole 331 of the plant pot in the upper surface at regular intervals; and a medicinal fluid grouting 333 formed in the forth and back portions of the upper surface of the suture plates 31′.

18. The plant cultivation system comprising according to claim 1, wherein the cultivating pot member 30 comprises: a can body 31 having an opening in the upper surface, a left and a right ends; a left and a right suture plates 31′ for bonding and suturing by adhering the left and the right ends of the can body 31; a hook plate 32 having a “∩” type upper end 32a and a “ [symbol] ” type lower end 32b, downwardly extended from one end of the upper end 32a, for installing in the middle portion of the upper surface of the left and the right suture plates 31′; and a medicinal fluid grouting 333 formed in the forth and back portions of the upper surface of the suture plates 31′.

19. The plant cultivation system comprising according to claim 1, wherein a forth and a back can bodies 31 formed lengthily in length and having an opening in the upper surface, a left and a right ends; a left and a right suture plates 31′ for bonding and suturing by adhering the opened left and right ends onto the forth and back side of each inner surface of the can bodies 31 to form a pathway 31b for penetrating in above and below between the can bodies; a medicinal fluid grouting 333 formed in the forth and back portions of the upper surface of the suture plates 31′; a hook plate 32 having a “∩” type upper end 32a and a “ [symbol] ” type lower end 32b, downwardly extended from one end of the upper end 32a, for installing in the middle portion of the upper surface of the left and the right suture plates 31′; and a cover plates 33 for covering and combining the upper surface of the forth and the back can bodies 31 and formed with a coupling hole 331 of the plant pot in the upper surface at regular intervals; and
the medicinal fluid supply 40 comprises: a cylinder 45 horizontally installed in the upper end of the right surface of the frame 13; a vertical cylinder 47 vertically fixed and installed on the load 451 of the cylinder 45; a distribution pipe 43 having a left end of the left and right ends 43b of the distribution pipes 43 combined into a guide groove 181 vertically formed in the inner side of the guide plate 18 located in the left side of the frame in order to vertically ascend or descend, and a right end fixed and installed on the upper end of the load 471 of the vertical cylinder 47; a collecting tank 48 is vertically fixed in the lower portion of the left and right ends 43b of the distribution pipes 43 to traverse toward left and right the inner upper portion; a supply valve 46 attached a load 451 of the cylinder 45 and slidably installed toward forth and back; and nozzles 43c for injecting the medicinal fluid into medicinal fluid groutings 333 in the course of moving with the same speed as the cultivating pot member 30 by ascending to the pathway 31b, and installing the medicinal fluid groutings 333 onto the facing surfaces of the can bodies 31 with a forth and a back surfaces of the distribution pipes 43 traversed toward left and right onto the inner upper side of the collecting tank 48.

20. The plant cultivation system comprising according to claim 19, wherein a collecting tank 48 is formed so that left and right surfaces are lower than the front and rear surfaces in height; the length between the left and right surfaces is some smaller than the interval between the left and the right of the cultivating pot member 30, and the length between the front and rear surfaces is some larger than the interval between the front and rear of the cultivating pot member 30; and includes a drain hole 481 of the medicinal fluid installed onto the lower surface.

21. The plant cultivation system comprising according to claim 6, wherein guide rails 14 supporting the left and right chain 23 are installed in the inner space of the frame 13; a roller rail 14′ is downwardly and integrally extended to the inner end of the lower surface of the guide rail 14; and a waterspout 16, in which the upper portion is opened, is fixed and installed to longitudinal direction in the lower end of the roller rail 14′; and
the cultivating pot member 30 comprises a roller 233 installed onto the left and right surfaces to be supported by the roller rail 14′; and an overflow tube 31a installed in any bottom surface of a left or right surface of the cultivating pot member 30 and located in the upper portion of the waterspout 16 for each lower end.

22. The plant cultivation system comprising according to claim 1, wherein an axis 24, for directly receiving the driving torque of the reduction motor 21 among axises 24 axis installed the plurality of left and right chain gear in each frame 13, becomes a long axis traversed toward left and right in the inner space of the frame 13, while axises 24 located in other places become a short axis not traversed toward left and right in the inner space of the frame 13.

23. The plant cultivation system comprising according to claim 22, wherein a diameter of the chain gear 22, axis installed in the axis 24 directly receive the driving torque of the deduction motor 21 among the plurality of left and right chain gear 22, is large in comparison with chain gears located in other places.

24. The plant cultivation system comprising according to claim 2, wherein the cultivating pot member 30 comprises: a can body 31 having an opening in the upper surface and a drain aperture 314 formed on the lower end; a binding part 312 excess formed in length direction in a front and rear surfaces of the upper end of the can body 31; and a holding plate 34 having an end, where a binding plate 341 is horizontally formed, to attach or detach onto the binding part, and the other end, which is downwardly and obliquely extended with slow angle from the end, is forwardly curved and formed.

25. The plant cultivation system comprising according to claim 3, wherein the cultivating pot member 30 comprises: a can body 31 having an opening in the upper surface and a drain aperture 314 formed on the lower end; a binding part 312 excess formed in length direction in a front and rear surfaces of the upper end of the can body 31; and a holding plate 34 having an end, where a binding plate 341 is horizontally formed, to attach or detach onto the binding part, and the other end, which is downwardly and obliquely extended with slow angle from the end, is forwardly curved and formed.

26. The plant cultivation system comprising according to claim 2,
wherein the cultivating pot member 30 comprises: a hook plate 32 having a “∩” type upper end for axis coupling by hanging onto the hook axis 26 and a lower end for installing a fixing plate 321 onto both ends of the upper surface of the can respectively, and a cover plate 33 combined to the opening to be covered the upper surface and formed with a coupling hole 331 of a plant pot 30a.

27. The plant cultivation system comprising according to claim 3,
wherein the cultivating pot member 30 comprises: a hook plate 32 having a “∩” type upper end for axis coupling by hanging onto the hook axis 26 and a lower end for installing a fixing plate 321 onto both ends of the upper surface of the can respectively, and a cover plate 33 combined to the opening to be covered the upper surface and formed with a coupling hole 331 of a plant pot 30a.

28. The plant cultivation system comprising according to claim 2,
wherein the cultivating pot member 30 comprises a can body 31 having an opening in the upper surface and vertically and lengthily formed; a hook plate 32 having a “∩” type upper end and a lower end for installing a fixing plate 321 onto both ends of the upper surface of the can body 31, respectively; a separation plate 36 formed with groutings 333 and fixed to be traversed toward left and right in the middle of the opened upper surface; left and right cover plates 33 covered and combined in the opened upper surface separated in left and right by the separation plate 36, respectively; and a gauge 35 coupled and installed on an installation hole formed in a one side of the fixing plates 321.

29. The plant cultivation system comprising according to claim 3,
wherein the cultivating pot member 30 comprises a can body 31 having an opening in the upper surface and vertically and lengthily formed; a hook plate 32 having a “∩” type upper end and a lower end for installing a fixing plate 321 onto both ends of the upper surface of the can body 31, respectively; a separation plate 36 formed with groutings 333 and fixed to be traversed toward left and right in the middle of the opened upper surface; left and right cover plates 33 covered and combined in the opened upper surface separated in left and right by the separation plate 36, respectively; and a gauge 35 coupled and installed on an installation hole formed in a one side of the fixing plates 321.

30. The plant cultivation system comprising according to claim 2,
wherein the cultivating pot member 30 comprises: a forth and a back can bodies 31 having an opening in the upper surface, a left and a right ends; a left and a right suture plates 31′ for bonding and suturing by adhering the left and the right ends of the can bodies 31; a “∩” type hook plate 32 constructed on the middle portion of the upper surface of the suture plate 31′; a cover plates 33 for covering and combining the upper surface of the forth and the back can bodies 31 and formed with a coupling hole 331 of the plant pot in the upper surface at regular intervals; and a medicinal fluid grouting 333 formed in the forth and back portions of the upper surface of the suture plates 31′.

31. The plant cultivation system comprising according to claim 3,
wherein the cultivating pot member 30 comprises: a forth and a back can bodies 31 having an opening in the upper surface, a left and a right ends; a left and a right suture plates 31′ for bonding and suturing by adhering the left and the right ends of the can bodies 31; a “∩” type hook plate 32 constructed on the middle portion of the upper surface of the suture plate 31′; a cover plates 33 for covering and combining the upper surface of the forth and the back can bodies 31 and formed with a coupling hole 331 of the plant pot in the upper surface at regular intervals; and a medicinal fluid grouting 333 formed in the forth and back portions of the upper surface of the suture plates 31′.

32. The plant cultivation system comprising according to claim 2,
wherein the cultivating pot member 30 comprises: a can body 31 having an opening in the upper surface, a left and a right ends; a left and a right suture plates 31′ for bonding and suturing by adhering the left and the right ends of the can body 31; a hook plate 32 having a “∩” type upper end 32a and a “ [symbol] ” type lower end 32b, downwardly extended from one end of the upper end 32a, for installing in the middle portion of the upper surface of the left and the right suture plates 31′; and a medicinal fluid grouting 333 formed in the forth and back portions of the upper surface of the suture plates 31′.

33. The plant cultivation system comprising according to claim 3,
wherein the cultivating pot member 30 comprises: a can body 31 having an opening in the upper surface, a left and a right ends; a left and a right suture plates 31′ for bonding and suturing by adhering the left and the right ends of the can body 31; a hook plate 32 having a “∩” type upper end 32a and a “ [symbol] ” type lower end 32b, downwardly extended from one end of the upper end 32a, for installing in the middle portion of the upper surface of the left and the right suture plates 31′; and a medicinal fluid grouting 333 formed in the forth and back portions of the upper surface of the suture plates 31′.
